(19) United States
(12) Patent Application Publication
(10) Pub. No.: US 2013/0143152 A1
(43) Pub. Date: Jun. 6, 2013

(54) CARRIER AND DEVELOPER FOR ELECTROSTATIC IMAGE DEVELOPMENT, AND IMAGE FORMATION METHOD AND APPARATUS

(71) Applicant: FUJI XEROX CO., LTD., Tokyo (JP)

(72) Inventors: Akira MATSUMOTO, Minamiashigara-shi (JP); Akihiro IIZUKA, Minamiashigara-shi (JP); Hiroyuki FUKUDA, Minamiashigara-shi (JP); Fusako KIYONO, Minamiashigara-shi (JP); Toshiyuki YANO, Minamiashigara-shi (JP)

(73) Assignee: FUJI XEROX CO., LTD., Tokyo (JP)

(21) Appl. No.: 13/731,870

(22) Filed: Dec. 31, 2012

Related U.S. Application Data
(62) Division of application No. 11/313,208, filed on Dec. 21, 2005, now abandoned.

(30) Foreign Application Priority Data
Jul. 25, 2005 (JP) 2005-215154
Jul. 25, 2005 (JP) 2005-215158
Aug. 18, 2005 (JP) 2005-237879

(51) Int. Cl. G03G 9/083

(52) U.S. Cl. CPC G03G 9/0833
USPC 430/106.2; 430/125.3

(57) ABSTRACT

A carrier for electrostatic image development, and a developer, an image formation method and an image formation apparatus using the carrier. The carrier is carrier particles. When the carrier particles each have a coating layer on a magnetic particle, the carrier has a total energy amount of 1500 to 3000 mJ. When the carrier particles each have a coating layer on a magnetic powder-dispersed particle, the carrier has a total energy amount of 1000 to 1500 mJ. The total energy amount is measured with a powder rheometer at a tip end speed of a rotor of 100 mm/s and a helix angle of the rotor of −5°. The total energy amount is a value of a portion of the carrier in a measurement container which portion is contained in the region between the packed surface of the carrier and a surface disposed under the packed surface by 70 mm.

### CROSS-REFERENCE TO RELATED APPLICATION

This application is a divisional of application Ser. No. 11/313,208 filed Dec. 21, 2005 which claims priority under 35 USC 119 from Japanese Patent Application Nos. 2005-215154, 2005-215158, and 2005-237879, the disclosures of which are incorporated by reference herein.

### BACKGROUND OF THE INVENTION

1. Field of the Invention

The present invention relates to a carrier for electrostatic image development, a developer for electrostatic image development, an image formation method, and an image formation apparatus to be used for development of electrostatic latent images by, for example, an electrophotographic method or an electrostatic recording method.

2. Description of the Related Art

A method for visualizing image information through electrostatic latent images by electrophotography is presently employed in various fields. In electrophotography, an image is obtained by forming an electrostatic image on a photoconductor (a latent image-holding member) in charging and exposing steps; developing the electrostatic image with a developer including a toner which contains a coloring agent and a binder resin to obtain a toner image; transferring the toner image to the surface of a recording material; and fixing the toner image on the recording material with, for example, a hot roll. The latent image-holding member is cleaned to remove the residual toner after transfer in order to enable formation of a next electrostatic image; however, when there is scarcely any residual toner left after transfer such as in the case of a spherical toner, the cleaning step may be omitted.

Developers (dry developers) used in the development include two-component developers containing a toner and a carrier, and single-component developers containing only a toner such as a magnetic toner. Single-component developers can be divided into magnetic single-component developers, which include magnetic powder and are transported to a development zone by a developer-carrying member by utilizing the magnetic force, and non-magnetic single-component developers which do not include magnetic powder and are transported to a development zone by a developer-carrying member by utilizing an electric field applied by a charging member such as a charging roll. On the other hand, with respect to two-component developers, the carrier is responsible for the functions of stirring, transporting, and electrically charging and thus the carrier and the toner separately take in charge of respective functions of the developer. Therefore, the developer properties are easy to control and two-component developers are presently employed widely. A developer containing a carrier coated with a resin coating is particularly excellent in charge controllability and it is relatively easy to make improvements in terms of the dependency thereof on the environment and stability over time.

As a development method, a cascade method had been employed before; however, today, a magnetic brush method using a magnetic roll as a developer-transporting/holding member is the mainstream.

From the latter half of 1980's, in the market of electrophotography, there has been high demand for higher functionality of apparatuses and the materials to be used in the apparatuses. With respect to full-color image quality, images with quality as high as those of high grade printings and silver halide photographs have been desired. With respect to monochromic images, high image quality has been desired similarly to that of full-color images. Further, with respect to apparatuses, high productivity, miniaturization, and cost cuts have been required. To achieve high quality, digitalization of apparatuses is essential, and digitalization makes it possible to carry out complicated image-processing at high speed and separate control of letters and photographic images. Accordingly, the reproducibility of full-color and monochromic images is remarkably improved as compared with using analog techniques. In particular, with respect to photographic images, the fact that color gradation correction and color correction are made possible is very advantageous as compared to the case of analog image formation, and color gradation characteristics, fineness, sharpness, color reproducibility, and graininess are superior to those in the case of analog image formation. With respect to image output, it is necessary to precisely visualize the electrostatic latent image produced by the optical system and, therefore, granulation of the toner has been yet further advanced and attempts to make reproduction yet more precise have been accelerated.

On the other hand, in order to attain miniaturization, it is necessary to reduce the number of parts. In addition, to cut costs, it is necessary to prolong the life of the consumable parts. Further, a developer is required to have higher functionality and higher reliability. In particular, a two-component developer is required to have longer life so as to lessen the frequency of replacement of the developer or to make replacement unnecessary. Further, to achieve high productivity, the speed of the latent image-holding member is increased. Therefore, in order to keep high quality, it becomes very important to improve the respective processes of development, transfer, fixation, and cleaning.

Along with this advancement of miniaturization and high speed processing of copying machines and printers, developing apparatuses themselves have to be made compact and operable at high speed. Consequently, improvement of the mechanical strength of the carrier is further required.

To meet such requirements, a technique for preventing breakage of a carrier and migration of the carrier to the photoconductor by using a magnetic powder-dispersed carrier and increasing the fluidity of the carrier is disclosed (see, for example, Japanese Patent Application Laid-Open (JP-A) No. 2002-328493). However, the fluidity is insufficient and carrier breakage cannot be prevented completely.

In the case of a toner with a small particle size, fluidity tends to be poor, and the fluidity of the toner is assured by adding an external additive with a small particle size to the toner. However, the external additive agent with a small particle size undesirably separates from the toner and migrates to the carrier.

To deal with the above problem, a method for controlling the toner particle diameter/carrier particle diameter/carrier specific gravity and suppressing the collision energy attributed to stirring has been proposed (see, for example, JP-A No. 2001-330985). However, the frictional electric charge decreases in this method. Therefore, when high density images are continuously outputted, density reproducibility deteriorates and fogging occurs. Further, when the rate of the new carrier supplied to the developer (tricle) is low or no supply is newly carried out, contamination due to the external additive cannot be prevented completely during long-term use.

Further, a method for adding a wax to the resin for coating the core of the carrier has been proposed (see, for example, JP-A No. 2004-170714).

However, if a soft substance like a wax exists on the carrier surface, the fluidity of the carrier decreases, which leads to occurrence of toner concentration unevenness in the developing unit, particularly at a high temperature and a high humidity.

Further in the case of a two-component developer, the charging property of the carrier decreases along with the contamination of the carrier surface by the toner components, which may cause fogging and toner crowding. In addition, the coating resin peels off from the carrier surface, which makes core particles with low resistance partially bare, decreases the resistance of the developer, and increases the amount of the carrier undesirably adhering to the latent image-holding member owing to the injection of the electric field in the development zone to such a developer. If the toner is made to have a small particle diameter, the toner surface area per unit weight is increased. In this case, if the carrier particle diameter is not changed, the toner coating rate on the carrier surface is so high as to make it impossible to electrically charge the toner sufficiently, and toner crowding or fogging tends to often occur. In order to avoid such a problem, when the toner particle diameter is made small, the particle diameter of the carrier tends to be made small. In such a manner, the particle diameter of the carrier is made small to correspond to the toner surface area, so that the surface area is widened and the toner is charged sufficiently and toner crowding and fogging are suppressed.

However, making the carrier particle diameter small can increase the surface area per unit weight, but decreases the magnetic force of each carrier particle. Therefore, the force of constraint by the magnetic field of the developer carrier weakens and the amount of the carrier adhering to the latent image-holding member consequently increases.

To solve this problem, a method of suppressing the adhesion of a carrier with a small particle diameter to a latent image-holding member has been proposed. For example, a method for carrier adhesion suppression by increasing the resistance of a carrier in the electric field in the development zone that applies a vibrating electric field has been disclosed (see, for example, JP-A No. 60-131549).

Although increasing the resistance of a carrier is certainly effective against carrier adhesion due to electric field injection, it simultaneously increases the resistance of the developer. Therefore, the degree of the influence of the effective electric field in a development zone on a latent image-holding member becomes too large. Further, after development, the electric charge with the opposite polarity to that of the toner which remains on the carrier cannot quickly escape to a developer-carrying member and image quality at the boundary of a high density portion and a low density portion worsens. Consequently, a developer containing such carrier and toner cannot satisfy the demands for high image quality of recent years.

Further, restriction of the relationship between carrier volume resistance, carrier particle diameter, and carrier magnetic force (see, for example, JP-A No. 5-66614) and suppression of carrier adhesion by controlling the coating rate of a resin coating core particles (see, for example, JP-A No. 7-234548) have been proposed.

Certainly, these methods are initially effective in suppressing carrier adhesion to a latent image-holding member. However, the stability of images over time is not mentioned. To obtain stable images in two-component development, the content in a developing unit is constantly stirred to stably charge the developer and to quickly charge the added toner. However, the stirring stress is not small. Therefore, stirring stress over a long duration causes the resin covering the surfaces of the carrier particles contained in the developer to gradually peel off. Accordingly, the carrier cannot maintain the initial resistance, and the resistance thereof becomes close to the level at which an electric charge is undesirably injected to the carrier, finally causing carrier adhesion, which does not occur in the initial period. This is especially apparent in double-sided copying or full color image formation. In the case of double-sided copying, after development, transfer, and fixation on one surface, the recording material is transported again to the exposure zone and an image is formed on the rear surface. During the process, the content in the developing unit is constantly stirred, so that the duration of stress application to the developer is longer than usual. In the case of full color image formation, particularly in tandem development, even when an image is obtained with one color being scarcely or not at all used in an image formation method using four color developers, the content in each of the developing units including the developing unit for the one color is stirred. Therefore, the amount of the stress to the developer is higher than in the case of monochromic image formation. As a result, peeling of the coating resin of the carrier often occurs, causing a significant decrease in the resistance of the carrier.

Consequently, a method of coating the carrier surface with a cross-linked silicone resin to control the surface properties of the carrier so as to satisfy both the charging property of the carrier and wear resistance of the coating resin has been proposed (see, for example, JP-A No. 11-133672).

However, the wear suppression described in this document is only to such an extent that the charging property of the carrier does not decrease and there is no description of carrier adhesion to a latent image-holding member. The peeling of the coating resin of the carrier does decrease the carrier resistance. However, the carrier having the residual coating resin has a charging property to a certain extent. Therefore, the degree of decrease in carrier resistance at the initial stage is not so high. Accordingly, fogging or toner scattering does not occur at this stage. However, resistance continues to decrease during continuous use of the carrier and finally reaches a level at which charge injection is induced. Consequently, charge is undesirably injected to the carrier and the carrier adheres to the latent image-holding member. Considering this fact, the carrier of this document is also insufficient in wear resistance and in suppression of carrier adhesion.

Accordingly, there are needs for a carrier for electrostatic image development which has an increased fluidity and which can therefore prevent powder generated by breakage of a carrier and blanking (missing portions) in an image owing to the powder, and an image formation method and an image formation apparatus using the same.

Also, there are needs for an electrostatic developer, an image formation method, and an image formation apparatus, which can suppress the adhesion of an external additive to the carrier, stabilize the charge/resistance of the carrier for a long duration, and give images with high quality.

Further, there are needs for a developer for electrophotography, an image formation method, and an image formation apparatus which can give high quality images for a long duration without quality defects due to carrier adhesion by suppressing peeling of the surface coating resin of the carrier over the long-term.

### SUMMARY OF THE INVENTION

The first aspect of the invention provides a carrier (carrier particles) for electrostatic image development each including a magnetic particle as a core and a coating layer coating the surface of the magnetic particle, wherein the total energy amount, measured with a powder rheometer at a tip end speed of a rotor of 100 mm/s and a helix angle of the rotor of −5°, of a portion of the carrier in a measurement container which portion is contained in a region between a packed surface and a surface disposed under the packed surface by 70 mm is 1500 to 3000 mJ.

The second aspect of the invention provides a developer for electrostatic image development containing a toner for electrostatic image development and a carrier (carrier particles) for electrostatic image development, wherein the toner for electrostatic image development includes toner mother particles each containing a binder resin and a coloring agent and having an average shape factor SF1 of 140 or lower, and each of the carrier particles for electrostatic image development includes a magnetic particle as a core and a coating layer coating the surface of the magnetic particle, and the total energy amount, measured with a powder rheometer at a tip end speed of a rotor of 100 mm/s and a helix angle of the rotor of −5°, of a portion of the carrier in a measurement container which portion is contained in a region between a packed surface and a surface disposed under the packed surface by 70 mm is 1500 to 3000 mJ.

The third aspect of the invention provides a developer for electrostatic image development containing a toner and a carrier (carrier particles), wherein the toner contains a binder resin, a coloring agent, and an external additive having a volume average particle diameter of 10 to 40 nm, and each of the carrier particles includes a magnetic particle as a core and a coating layer coating the surface of the magnetic particle, and the total energy amount, measured with a powder rheometer at an air flow of 10 cc/min, a tip end speed of a rotor of 100 mm/s and a helix angle of the rotor of −10°, of a portion of the carrier in a measurement container which portion is contained in a region between a packed surface and a surface disposed under the packed surface by 70 mm is 1420 to 2920 mJ.

The fourth aspect of the invention provides an image formation method including: electrically charging a latent image-holding member, exposing the charged latent image-holding member to light to form an electrostatic latent image on the latent image-holding member, developing the electrostatic latent image with a developer containing a toner and a carrier to form a toner image, and transferring the toner image from the latent image-holding member to a recording material; wherein the carrier includes the carrier of the first aspect for electrostatic image development, and in the developing, a developer-carrying member is provided, faces the latent image-holding member, holds the developer on the surface thereof and is rotated at a peripheral speed of 200 to 600 mm/s to transport the developer to the latent image-holding member.

The fifth aspect of the invention provides an image formation apparatus having a latent image-holding member, a charging unit for electrically charging the latent image-holding member, an exposure unit for forming an electrostatic latent image on the latent image-holding member, a development unit for developing the electrostatic latent image with a developer to form a toner image, a transfer unit for transferring the toner image from the latent image-holding member to a recording material; wherein the developer contains the carrier for electrostatic image development of the first aspect.

The sixth aspect of the invention provides a carrier (carrier particles) for electrostatic image development each including a magnetic powder-dispersed particle as a core and a coating layer coating the surface of the magnetic powder-dispersed particle, wherein the total energy amount, measured with a powder rheometer at a tip end speed of a rotor of 100 minis and a helix angle of the rotor of −5°, of a portion of the carrier in a measurement container which portion is contained in a region between a packed surface and a surface disposed under the packed surface by 70 mm is 1000 to 1500 mJ.

The seventh aspect of the invention provides a developer for electrostatic image development containing a toner for electrostatic image development and a carrier (carrier particles) for electrostatic image development, wherein the toner for electrostatic image development comprises toner mother particles each containing a binder resin and a coloring agent and having an average shape factor SF1 of 140 or lower, and each of the carrier particles for electrostatic image development includes a magnetic powder-dispersed particle as a core and a coating layer coating the surface of the magnetic particle, and the total energy amount, measured with a powder rheometer at a tip end speed of a rotor of 100 mm/s and an helix angle of the rotor of −5°, of a portion of the carrier in a measurement container which portion is contained in a region between a packed surface and a surface disposed under the packed surface by 70 mm is 1000 to 1500 mJ.

The eighth aspect of the invention provides a developer for electrostatic image development containing a toner and a carrier (carrier particles), wherein the toner contains a binder resin, a coloring agent, and an external additive having a volume average particle diameter of 10 to 40 nm, and each of the carrier particles includes a magnetic powder-dispersed particle as a core and a coating layer coating the surface of the magnetic powder-dispersed particle, and the total energy amount, measured with a powder rheometer at an air flow of 10 cc/min, a tip end speed of a rotor of 100 mm/s and a helix angle of the rotor of −10°, of a portion of the carrier in a measurement container which portion is contained in a region between a packed surface and a surface disposed under the packed surface by 70 mm is 890 to 1390 mJ.

The ninth aspect of the invention provides an image formation method including: electrically charging a latent image-holding member, exposing the charged latent image-holding member to light to form an electrostatic latent image on the latent image-holding member, developing the electrostatic latent image with a developer containing a toner and a carrier to form a toner image, and transferring the toner image from the latent image-holding member to a recording material; wherein the carrier comprises the carrier of the sixth aspect for electrostatic image development, and in the developing, a developer-carrying member is provided, faces the latent image-holding member, holds the developer on the surface thereof and is rotated at a peripheral speed of 200 to 600 mm/s to transport the developer to the latent image-holding member.

The first, fourth to sixth and ninth aspects of the invention can provide a carrier for electrostatic image development, an image formation method, and an image formation apparatus having an increased fluidity of a carrier, which prevents the carrier to be broken into power, which causes formation of images having missing portions.

The third and eighth aspects of the invention can provide a developer for electrostatic image development which suppresses adhesion of an external additive to a carrier, stabilizes charge and/or resistance for a long period of time and enables output of high quality images.

The second and seventh aspects of the invention can provide a developer for electrostatic image development which suppresses peeling of the coating resin of a carrier which peeling often occurs with passage of time in conventional carriers, and adhesion of the carrier to a latent image-holding member and therefore enables formation of high quality images free from defects.

### BRIEF DESCRIPTION OF THE DRAWINGS

Preferred embodiments of the invention will be described in detail based on the following figures, wherein:

FIG. 1A is a drawing for explaining a measurement method of total energy amount by a powder rheometer, FIG. 1B is a graph showing the relationship between vertical load and the depth of the carrier layer contained in a measurement container, and FIG. 1C is a graph showing the relationship between rotation torque and the depth of the carrier layer contained in the measurement container;

FIG. 2 is a graph showing the relationship between energy gradient obtained by the powder rheometer measurement and the depth of the carrier layer contained in the measurement container; and

FIG. 3 is the front view of the rotor used in the powder rheometer.

### DETAILED DESCRIPTION OF THE INVENTION

Generally, the core of a carrier for electrostatic image development (hereinafter, referred to as a carrier in some cases) can be broadly classified into two types: those each of which is a magnetic particle and those each of which is a magnetic powder-dispersed particle. Examples of the former include an iron powder carrier, a ferrite carrier, and ferrite-iron powder. Examples of the latter, the magnetic powder-dispersed particles, include those in which magnetic powder is dispersed in a resin.

The core which is the former magnetic particle has a high specific gravity and a very high degree of saturation magnetization, whereby fluidity and stirring property thereof easily deteriorate. Further, it has a big impact on a toner and a photoconductor during stirring, whereby a toner-spent phenomenon (contamination of a carrier with a toner) easily undesirably occurs and the photoconductor is easily scratched.

Considering such problems, a coating layer is formed on the surface of each magnetic particle to improve fluidity and charge controllability of the toner. The coating layer is generally formed by a solution method using a solution containing a resin. However, since iron powder or ferrite has low surface energy and insufficient wettability with the resin, the coating layer tends to be uneven and easily undesirably peels off due to stirring in a developing unit.

On the other hand, the latter magnetic powder-dispersed carrier forms softer magnetic brushes (also called as ears.) than the former magnetic particle carrier. This enables formation of an image with a high and even image density and high precision.

However, in the latter, wettability between the magnetic powder and a resin is poor and the magnetic powder easily undesirably agglomerates under the effect of residual magnetization. Therefore, it is difficult to evenly disperse the magnetic powder in the resin without agglomeration, in the above-described production method. When a magnetic power-dispersed carrier is used in which the magnetic powder undesirably agglomerates, the carrier particles gradually crack or chip due to stirring in a developing unit, which undesirably changes charging property and fluidity of the carrier, partially lays bare the hard magnetic particles on the carrier surface, or scratches the photoconductor.

Thus, in both of the former and the latter carriers, the problems regarding the carrier are closely relevant to the fluidity of the carrier.

Therefore, the carrier for electrostatic image development according to each of the first, fourth to sixth and ninth aspects of the invention has a core and a coating layer covering the surface of the core, resulting in improvement in fluidity and charge controllability of the carrier.

The inventors of the invention have found that the total energy amount measured with a powder rheometer in which an air flow is set to 10 cc/min, the tip end speed of a rotor is set to 100 mm/s and the helix angle of the rotor is set to −10° has a close correlation with fluidity of the carrier in a developing unit to which a toner is frequently added.

Further, the inventors have also found the following fact. When the total energy amount measured with the powder rheometer and a property of the external additive to be added to the surfaces of toner particles are within the above-defined ranges, fluidity of the toner can be ensured and, at the same time, stress which is applied to the carrier due to stirring in a developing unit can be reduced, suppressing undesired adhesion of the external additive to the carrier.

The carrier and the toner in the developing unit being in such states can suppress decrease in charging property of the carrier and lessen frequency of “fogging” owing to low charge. Further, since decrease in resistance of the carrier is suppressed, an image free from defects such as “colored spots” or “blank spots” can be obtained. Moreover, since fluidity of the carrier is good, frequency of contact between the toner and the carrier is increased, and the toner is sufficiently charged. Therefore, even if high density images are continuously outputted, images with good density reproducibility can be obtained.

The inventors of the invention thought the following thing in devising the invention. For drastic prevention of peeling of the coating resin on the carrier surface which peeling is caused by stirring stress in a developing unit, it is important to use a developer with little stirring stress during stirring in a developing apparatus. A developer is fluidized (moved) by the stirring force of a rotor such as an auger or a magnet roll in a developing apparatus and the developer on the magnet roll is made to flow (at a flow controlling portion) before a development nip. At that moment, very strong force is applied to the developer, causing the coating resin of the carrier to undesirably peel. At the same time, the transportation amount of the developer is controlled in the flow controlling portion and the developer thus stagnates and packs before the portion. This increases the stress against the developer and causes the carrier coating to undesirably peel.

The inventors of the invention have found the following fact. In order to obtain a developer capable of decreasing such stirring stress in a developing unit, it is very important that a toner includes toner mother particles having an average shape factor SF1 of 140 or lower. At the same time, it is very important that, in the case of a carrier for electrostatic image development containing magnetic particles serving as cores and a coating layer covering the surface of each of the magnetic particles, the carrier has a total energy amount of about 1500 to about 3000 mJ, or that, in the case of a carrier for electrostatic image development containing magnetic powder-dispersed particles serving as cores and a coating layer covering the surface of each of the magnetic powder-dispersed particles, the carrier has a total energy amount of about 1000 to about 1500 mJ. The total energy is measured with a powder rheometer in which the tip end speed of a rotor is set to 100 mm/s and the helix angle of the rotor is set to −5°. The total energy is a measured value of a portion of a carrier in a measurement container which portion is contained in the region between the packed surface (top surface) of the carrier and a surface disposed under the packed surface by 70 mm. In such cases, the carrier coating hardly peels even when the carrier is stirred by an auger or a magnetic roll in a developing apparatus.

In other words, the total energy amount being large means the load which stirring stress gives the carrier is high. That is, the amount of energy applied to the developer is large and that of stress against the developer is also large. Therefore, to simply suppress peeling of the coating resin of the carrier, it is desirable that the total energy amount is the minimum. However, when the total energy amount is the minimum, fluidity of the developer in the developer flow controlling portion before the development nip becomes so good that an excess amount of the developer passes through the flow controlling portion. Consequently, the developer amount at the development nip portion becomes variable, whereby image density significantly changes. In an extreme case, fogging and jamming owing to an excess amount of the developer take place. Further, in the case where the total energy amount of the carrier is too small, friction force which is caused by stirring and whereby the toner is electrically charged in a contact state decreases and thus charging speed lowers.

Here, when the average shape factor SF1 of the toner mother particles is made more than 140 to improve friction force between the carrier and the toner, the friction force between the toner and the carrier is surely ensured to a certain extent and the charging speed is not decreased so much even in the case where the total energy amount is too small. However, the total energy amount of the carrier being made small results in that the degree of decrease in the amount of stress against the developer in a developing apparatus does not reach expectation and that the coating resin of the carrier therefore peels.

The reason for this is as follows. When the average shape factor of the toner mother particles exceeds 140, it becomes hard to fluidize the toner on the carrier surface. Therefore, when the developer receives stress in the developer flow control portion before the development nip, the toner cannot be easily fluidized and therefore the developer cannot roll, which cannot release the stress well. On the contrary, when the shape factor of the toner mother particles is 140 or lower, and when the developer receives stress in the flow control portion, the toner slightly moves on the carrier surface, and therefore the developer can smoothly pass through the flow control portion and can be transported to the development nip portion without receiving stress.

In particular, when an external additive is added to the surfaces of the toner mother particles, the external additive particles exiting on the surfaces of the toner mother particles decrease the number of contact points between the toner and the carrier to control adhesion between the toner and the carrier. This and rolling movement of the external additive itself on the toner surfaces can provide such an effect as that of a roller, which causes the developer to is easily fluidized and prevents the developer from receiving stress. Accordingly, in the invention, the toner preferably includes an external additive.

The above-mentioned conditions are particularly effective in the case of a high speed apparatus and they are more particularly effective in the case of a development system in which the peripheral speed of a latent image-holding member is about 100 to about 600 mm/sec, in which that of a developer-carrying member is very high and in which the ratio of the peripheral speed of the developer-carrying member to that of the latent image-holding member is about 1.5 to about 2.0 to assure sufficient developability even in the high speed apparatus.

Thus, the inventors of the invention have found that, when the shape factor SF1 of the toner mother particles and the total energy amount of the carrier are controlled separately, the effects of the second and seventh aspects of the invention cannot be obtained but that, when the two factors are made within the respective ranges on the basis of optimum charging speed, the effects can be obtained.

Accordingly, a developer for electrophotography and an image formation method using the developer by which images with high quality free from image defects caused by carrier adhesion can be obtained by suppressing peeling of the coating resin on the carrier surface for a long period of time.

Next, measurement of fluidity of a carrier by a powder rheometer will be described.

Measurement of fluidity of particles is affected by more factors than measurement of fluidity of a liquid, a solid, or a gas. Therefore, it is difficult to specify precise fluidity of particles by using parameters employed conventionally such as the diameter or the surface roughness of particles. Further, even when a factor (e.g. particle diameter) which affects the fluidity is found, the factor may only give a small impact on the fluidity. Alternatively, measurement of the factor may be meaningful only when the factor is combined with other specific factor(s). Therefore, it is very difficult to determine the factor(s) to be measured.

Further, fluidity of powder greatly depends on external environmental factors. In contrast, even if the measurement environment fluctuates, the fluctuation range of fluidity of for example, liquid is not so wide. Meanwhile, fluidity of particles greatly depends on external environmental factors such as humidity and the state of gas used to fluidize the particles. It has been unclear so far which of the measurement factors is affected by these external environmental factors. Therefore, even if measurement of fluidity is carried out under strict measurement conditions, the measurement values are, practically, poorly reproducible.

Regarding fluidity of toner particles or a carrier with which a development tank has been charged, the angle of repose and the bulk density have been employed as indexes. However, these physical values indirectly relate to the fluidity and thus it is difficult to quantify and control the fluidity.

On the contrary, a powder rheometer enables measurement of the total amount of energy which the carrier applies to the rotor of the measurement apparatus, so that a value reflecting the respective factors attributed to the fluidity can be obtained. Therefore, the powder rheometer enables direct measurement of fluidity of the carrier without determining items to be measured of a carrier having adjusted surface physical properties and an adjusted particle size distribution and finding the optimum physical values for the respective items and measuring them, which is conventionally needed. As a result, it becomes possible to judge whether a carrier is suitable for electrostatic image development, by confirming whether the value measured by the powder rheometer is within the range alone. With respect to keeping fluidity of a carrier constant, such production control of a carrier is an extremely practical method as compared with a conventional method of controlling an indirect value. Further, it is easy to keep measurement conditions constant and thus reproducibility of measurement values is also high in such production control.

In other words, the method of specifying fluidity by the value obtained by the powder rheometer is simpler, more precise, and more highly reliable than the conventional method.

Here, regarding the first, second, fourth to seventh, and ninth aspects, the inventors of the invention have found that, in order to suppress powder formation owing to breakage of carrier particles and occurrence of images having missing portions caused by the powder or in order to suppress peeling of the surface coating resin of a carrier, it is very effective that a carrier for electrostatic image development has a value, measured with a powder rheometer under the above-mentioned conditions, in the range of about 1500 to about 3000 mJ in the case where the carrier includes a magnetic particle as the core thereof, or in the range of about 1000 to about 1500 mJ in the case where the carrier includes a magnetic powder-dispersed particle as the core thereof. When a carrier having the value within the above range is used in electrostatic image development, fluidity thereof can be ensured, and the amount of stress caused by collision among the carrier particles can be lessened. As a result, since powder formation owing to cracking of a carrier does not occur, image defects such as missing of image portions on a transfer material such as paper which missing is caused by migration of the powder to a photoconductor can be prevented.

With respect to a carrier whose core is a magnetic particle, in the case where the above-mentioned value measured with the powder rheometer is lower than bout 1500 mJ, the friction effect of the carrier is insufficient, making it difficult to sufficiently charge a toner. On the other hand, in the case where the value exceeds about 3000 mJ, the amount of stress against the carrier becomes large, making it difficult to suppress powder formation owing to carrier breakage and to suppress peeling of the surface coating resin of the carrier. The measured value is preferably in the range of about 1800 to about 2700 mJ and more preferably in the range of about 2000 to about 2500 mJ.

With respect to a carrier whose core is a magnetic powder-dispersed particle, in the case where the above-mentioned value measured by the powder rheometer is lower than about 1000 mJ, the friction effect of the carrier is insufficient, making it difficult to sufficiently charge a toner. On the other hand, in the case where the value exceeds about 1500 mJ, the amount of stress against the carrier becomes large, making it difficult to suppress powder formation owing to carrier breakage and to suppress peeling of the surface coating resin of the carrier. The measured value is preferably in the range of about 1100 to about 1400 mJ and more preferably in the range of about 1200 to about 1300 mJ.

Further, with respect to the third and eighth aspects, the inventors of the invention have found that, in order to suppress powder formation owing to breakage of carrier particles and occurrence of blank in images caused by the powder, it is very effective that a carrier for electrostatic image development has a value, measured with a powder rheometer under the above-mentioned conditions, in the range of about 1420 to about 2920 mJ in the case where the carrier includes a magnetic particle as the core thereof, or in the range of about 890 to about 1390 mJ in the case where the carrier includes a magnetic powder-dispersed particle as the core thereof. When a carrier having the value within the above range is used in electrostatic image development, fluidity thereof can be ensured, and the amount of stress caused by collision among the carrier particles can be lessened. As a result, since powder formation owing to cracking of a carrier does not occur, image defects such as missing of image portions on a transfer material such as paper which missing is caused by migration of the powder to a photoconductor can be prevented.

With respect to a carrier whose core is a magnetic particle, in the case where the above-mentioned value measured with the powder rheometer is lower than about 1420 mJ, the friction effect of the carrier is insufficient, making it impossible to sufficiently charge a toner. On the other hand, in the case where the value exceeds about 2920 mJ, the amount of stress against the carrier becomes large, making it impossible to suppress powder formation owing to carrier breakage. The measured value is preferably in the range of about 1720 to about 2620 mJ and more preferably in the range of about 1920 to about 2420 mJ.

With respect to a carrier whose core is a magnetic powder-dispersed particle, in the case where the above-mentioned value measured by the powder rheometer is lower than about 890 mJ, the friction effect of the carrier is insufficient, making it impossible to sufficiently charge a toner. On the other hand, in the case where the value exceeds about 1390 mJ, the amount of stress against the carrier becomes large, making it impossible to suppress powder formation owing to carrier breakage. The measured value is preferably in the range of about 990 to about 1290 mJ and more preferably in the range of about 1090 to about 1190 mJ.

The compositions of the respective carriers will be described later.

Next, a measurement method with a powder rheometer will be described.

A powder rheometer is a fluidity measurement apparatus in which vertical load and rotation torque obtained by spirally rotating a rotor in packed particles are simultaneously measured to directly obtain fluidity of the particles. Simultaneous measurement of the rotation torque and vertical load makes it possible to detect fluidity which reflects influence of the characteristics of powder itself and that of the external environment at a high sensitivity. Also, since the measurement is carried out in the state where the packed state of the particles is kept constant, data with good reproducibility can be obtained.

In the invention, FT 4 manufactured by Freeman Technology is employed as the powder Rheometer.

At first, a carrier whose fluidity is to be measured is packed in a container. The container has an inner diameter of 50 mm, a height of 88 mm, and a capacity of 160 mL. The layer of the carrier packed in the container has a height of 88 mm. Next, in the third and eighth aspects, the packed carrier is transferred to a container having an inner diameter of 50 mm, a height of 140 mm, and a capacity of 200 mL.

Before measurement, the carrier is left at a temperature of 22° C. and a humidity of 50% RH for eight hours or longer so as to prevent occurrence of errors attributed to external environmental factors at the time of measurement.

After the carrier is left, to eliminate fluctuation of measurement value owing to alteration of packing conditions, conditioning of the packed carrier is carried out before fluidity measurement. In the conditioning, a rotor is slowly rotated in the packed carrier in a rotation direction (opposed to the rotation direction at the time of measurement), in which the rotor receives no resistance of the carrier, so that no stress is applied to the carrier. Thereby, excess air and partial stress are removed and the sample carrier is homogenized.

In the first, second, fourth to seventh, and ninth aspects, after completion of the conditioning, the rotor is rotated while the rotor is moved downward in the packed carrier.

In the third and eighth aspects, after completion of the conditioning, the following operation is conducted. While air is introduced into the container at an air flow of 10 cc/min, the rotor is put into the packed carrier and rotated in the carrier. In this case, the reason why the measurement is carried out while air is being introduced into the container is to make the state of the carrier packed in the container approximate the fluidization state of a toner and a carrier in a stirring apparatus. The air flow of 10 cc/min has a correlation with the fluidization state of a developer in a developing unit to which a toner is added frequently. The influx state of the air flow is specified in FT4 manufactured by Freeman Technology.

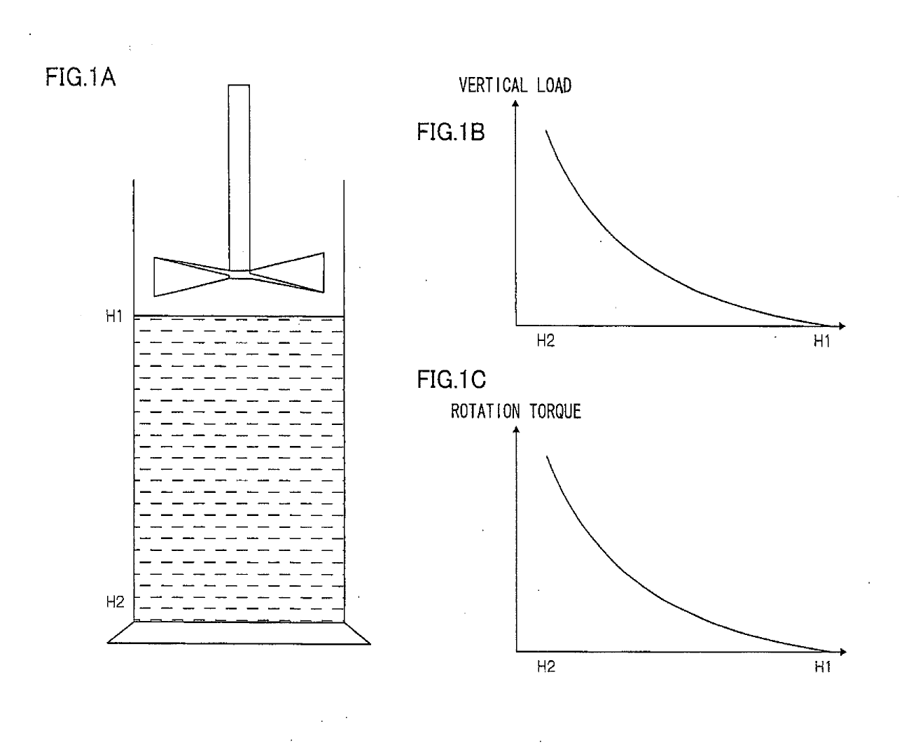

As shown in FIG. 1A, a rotation torque and a vertical load are measured when a rotor is moved at a helix angle of −5° (the first, second, fourth to seventh, and ninth aspects) or −10° (the third and eighth aspects) from the packed surface H1 to a surface H2 in particles packed in a container and, at the same time, is rotated at a tip end speed of 100 mm/s. The reason why the helix angle is controlled to −5° is that sensitivity of the power rheometer is the highest in measurement of the fluidization state of the carrier. The reason why the helix angle is controlled to −10° is that such a helix angle has a close correlation with fluidity of a developer in a developing apparatus.

The helix angle means the angle which the edge of rotor shows against the surface of carrier when the rotor is moved downward in the packed carrier.

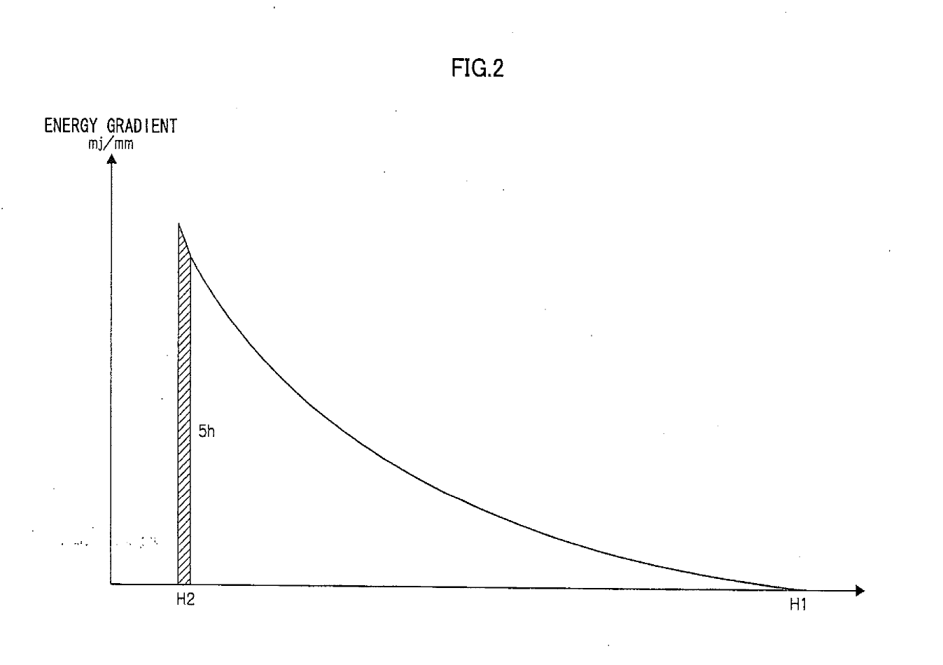

FIG. 1B and FIG. 1C show a relation of rotation torque or vertical load to depth H from the packed surface H1. FIG. 2 shows energy gradient (mJ/mm) to depth II, which is obtained from the rotation torque and the vertical load. The area (area in which slant lines are drawn in FIG. 2) obtained by integrating the energy gradient in FIG. 2 corresponds to a total energy amount (mJ). In this invention, the surface H2 is positioned at a depth of 70 mm from the packed surface H1.

In this invention, to suppress the effects of errors, the measurement operation is repeated five times and the resultant values are averaged and the resultant average is defined as the total energy amount (mJ) recited in the invention.

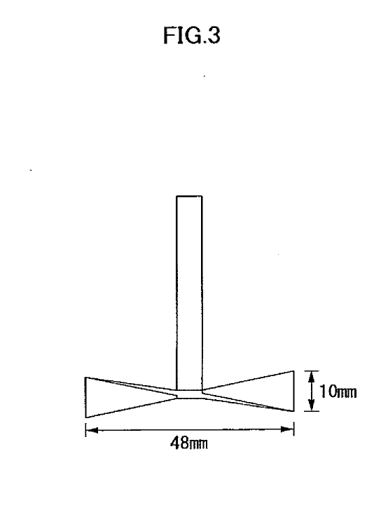

A two-blade-propeller-type blade shown in FIG. 3, having a diameter of 48 mm and manufactured by Freeman Technology is used as the rotor.

The composition of the carrier having a total energy amount within the above-mentioned range will be described.

The carrier of the invention needs to meet the above-mentioned conditions but otherwise it is not particularly limited. Examples of carrier particles which satisfy the above-mentioned value include those having a sufficiently narrow particle diameter distribution; those having, on the carrier core surface, a coating layer of a material which can decrease frictional resistance; those having a spherical shape; those having a sufficiently narrow shape distribution; those scarcely containing agglomerates; those having a low specific gravity; those having a low density; and those having voids in the inside. One of these may be used alone or two or more of them can be used together.

In the carrier of the invention, the material of the core is not particularly limited. Hereinafter, a carrier having a magnetic particle as the core (the first embodiment of the carrier) and a carrier having a magnetic powder-dispersed particle as the core (the second embodiment of the carrier) will be described separately.

### —Carrier of First Embodiment (Carrier Particle Having Magnetic Particle as Core)—

In the carrier of the first embodiment, examples of the material of the core include magnetic metals such as iron, steel, nickel, and cobalt, alloys of at least one of these metals with manganese, chromium, and/or a rare earth element (e.g. nickel-iron alloy, cobalt-iron alloy, and aluminum-iron alloy), and magnetic oxides such as ferrite and magnetite. From the viewpoint of employment of a magnetic brush method as a development manner, the core is preferably a magnetic particle.

The volume average particle diameter of the cores in the carrier of the first embodiment is preferably about 10 μm to about 500 μm. In the first, and third to fifth aspects, the volume average particle diameter is more preferably about 30 μm to about 150 μm and even more preferably about 30 μm to about 100 μm. In the second aspect, the volume average particle diameter is more preferably about 20 μm to about 150 μm, and even more preferably about 25 μm to about 100 μm. When carrier particles having a core with a volume average particle diameter of smaller than about 10 μm are used in electrostatic image development, the adhesion between a toner and the carrier is strong, which decreases the amount of the toner used in development. On the other hand, when the volume average particle diameter of the carrier cores exceeds about 500 μm, the particles composing a magnetic brush are coarse, which makes it difficult to form fine and dense images. Considering the total energy amount, the magnetic force of each carrier particle is small and adhesion of carrier to a latent image-holding member easily occurs, if the volume average particle diameter of the cores is smaller than about 10 μm. Meanwhile, if it exceeds about 500 μm, the surface area of the carrier particle is too small relatively to the surface area of the toner particles, which makes it impossible to sufficiently charge the toner.

The volume average particle diameter of the cores in the carrier of the first embodiment is a value measured with a laser diffraction/scattering-type particle size distribution measurement apparatus (LS PARTICLE SIZE ANALYZER LS 13 320 manufactured by BECKMAN COULTER). When the whole particle size range of the resultant particle size distribution is divided into several size ranges (channels) and a volume cumulative distribution curve is drawn from the smallest range, the volume average particle diameter D50V is the particle diameter at a cumulative count of 50%.

Regarding the particle diameter distribution of the cores in the carrier of the first embodiment, the ratio of the volume particle diameter D_{84V} to the volume average particle diameter D_{50V} is preferably 1.20 or lower and more preferably 1.15 or lower. The ratio of the number average particle diameter D_{50P} to the number particle diameter D_{16P} is preferably 1.25 or lower and more preferably 1.20 or lower

To obtain cores having the above-mentioned particle diameter distribution, magnetic particles can be classified with a vibrating sieving apparatus, a gravity-type classifier, a centrifugation-type classifier, an inertia classifier, or a sieve according to a desired size distribution.

To obtain carrier cores having the above-mentioned particle diameter distribution, a vibrating sieving apparatus and an air classifier are particularly preferably used. It is particularly preferable to conduct sieving of multi steps or simultaneously remove fine powder and coarse powder.

In the case where the particle diameter distribution of the carrier cores is broader than the above-mentioned range, the total energy amount measured with a powder rheometer is out of the recited range. On the other hand, making the particle diameter distribution narrower than the above-mentioned range requires excessive work in, for example, classification and thus considerably worsens working efficiency.

The particle diameter distribution of the cores is measured with a laser diffraction/scattering-type particle size distribution measurement apparatus (LS PARTICLE SIZE ANALYZER LS13 320 manufactured by BECKMAN COULTER). When the whole particle size range of the resultant particle size distribution is divided into several size ranges (channels) and a volume cumulative distribution curve is drawn from the smallest range, the diameter at a cumulative count of 84% is a particle diameter D_{84V}. When a number cumulative distribution curve is drawn from the smallest range, the diameter at a cumulative count of 50% is a particle diameter D_{50P}, and the diameter at a cumulative count of 16% is a particle diameter D_{16P}. The ratio of the volume particle diameter D_{84V} to the volume average particle diameter D_{50V} is defined as a particle size distribution index at a coarse particle side. The ratio of the number average particle diameter D_{50P} to the number particle diameter D_{16P} is defined as a particle size distribution index at a particle side.

The density of the core in the carrier of the first embodiment is preferably about 3.0 to about 8.0 g/cm³, more preferably about 3.5 to about 7.0 g/cm³, and even more preferably about 4.0 to about 6.0 g/cm³. If the density is lower than about 3.0 g/cm³, fluidity of the carrier is close to that of the toner, which results in deteriorated charge supply capability of the carrier. If the density is higher than about 8.0 g/cm³, fluidity of the carrier is poor and the total energy amount tends to exceed the upper limit value.

The density of the core is measured by a method described in Physicochemical Experimental Methods, Density Section, third edition, Tokyo Kagaku Dojin Co., Ltd. In the measurement, pure water with electric resistance of 17 MΩ or more is used and the measurement is carried out at a temperature of 25° C.

The carrier in the invention has a core and a coating layer on the surface of the core. The coating layer is preferably a coating resin layer containing a matrix resin.

The matrix resin may be an ordinary one. Examples thereof include polyolefin resins such as polyethylene and polypropylene; polyvinyl and polyvinylidene resins such as polystyrene, acrylic resins, polyacrylonitrile, polyvinyl acetate, polyvinyl alcohol, polyvinyl butyral, polyvinyl chloride, polyvinyl carbazole, polyvinyl ether, and polyvinyl ketone; vinyl chloride-vinyl acetate copolymer; styrene-acrylic acid copolymer; straight silicone resins containing organosiloxane bonds and modified products thereof; fluorinated resins such as polytetrafluoroethylene, polyvinyl fluoride, polyvinylidene fluoride, and polychlorotrifluoroethylene; polyesters; polyurethanes; polycarbonates; phenol resins; amino resins such as urea-formaldehyde resins, melamine resins, benzoguanamine resins, urea resins, and polyamide resins; silicone resins; and epoxy resins.

One of these may be used alone or two or more of them may be used together.

To prevent pollution caused by toner components, it is preferable to use a resin with low surface energy such as a fluorinated resin or a silicone resin as the coating resin. It is more preferable to use a fluorinated resin for coating.

Examples of the fluorinated resin include fluorinated polyolefin; fluoroalkyl (meth)acrylate homopolymer and copolymer; vinylidene fluoride homopolymer and copolymer; and mixtures thereof. Typical examples of monomer(s) containing at least one fluorine atom which monomer(s) is the raw material(s) of the fluorinated resin include, but are not limited to, fluoroalkyl methacrylate monomers such as tetrafluoropropyl methacrylate, pentafluoropropyl methacrylate, octafluoropentyl methacrylate, perfluorooctylethyl methacrylate, and trifluoroethyl methacrylate.

The content of the fluorine-containing monomer(s) is preferably in the range of about 0.1 to about 50.0% by mass, more preferably in the range of about 0.5 to about 40.0% by mass, and even more preferably in the range of about 1.0 to about 30.0% by mass with respect to all the monomers of the coating resin. If the content is lower than about 0.1% by mass, it becomes difficult to ensure contamination resistance. If the content exceeds about 50.0% by mass, adhesion of the coating resin to the core is weak, which may result in a decreased charging property.

The content of the matrix resin contained in the coating resin layer is preferably in the range of about 0.5 to about 10% by mass, more preferably in the range of about 1.0 to about 5.0% by mass, and even more preferably in the range of about 1.0 to about 4.0% by mass with respect to the entire weight of the carrier. If the content is lower than about 0.5% by mass, the magnetic core particle is easily laid bare on the carrier surface and the electric resistance of the carrier easily decreases. On the other hand, if the content exceeds about 10% by mass, fluidity of the carrier is considerably poor and it becomes difficult to evenly charge a toner.

The coating layer may contain resin particles dispersed therein.

The resin particles may be, for example, thermoplastic resin particles or thermosetting resin particles. Among them, thermosetting resin particles, which can relatively easily increase hardness of the coating layer, are preferable. Moreover, nitrogen atom-containing resin particles are preferable to provide a toner with negative chargeability. Particles of one kind of these resins may be used or those of two or more kinds of them may be used together.

It is preferable that the resin particles are dispersed in the matrix resin as evenly both in a direction parallel to the thickness of the coating resin layer and in a direction parallel to the tangential line with respect to the carrier surface as possible. The resin of the resin particles and the matrix resin having high compatibility improves evenness in dispersion of the resin particles in the coating resin layer.

Examples of the resin of the thermoplastic resin particles include polyolefin resins such as polyethylene and polypropylene; polyvinyl and polyvinylidene resins such as polystyrene, acrylic resins, polyacrylonitrile, polyvinyl acetate, polyvinyl alcohol, polyvinyl butyral, polyvinyl chloride, polyvinyl carbazole, polyvinyl ether, and polyvinyl ketone; vinyl chloride-vinyl acetate copolymer; styrene-acrylic acid copolymer; straight silicone resins containing organosiloxane bonds and modified products thereof; fluorinated resins such as polytetrafluoroethylene, polyvinyl fluoride, polyvinylidene fluoride, and polychlorotrifluoroethylene; polyesters; polyurethanes; and polycarbonates.

Examples of the resin of the thermosetting resin particles include phenol resins; amino resins such as urea-formaldehyde resins, melamine resins, benzoguanamine resins, urea resins, and polyamide resins; silicone resins; and epoxy resins.

The resin of the resin particles may be the same as or different from the matrix resin. It is preferable that the resin of the resin particles is different from the matrix resin.

If thermosetting resin particles are used as the resin particles, the mechanical strength of the carrier can be improved. In particular, the resin preferably has a cross-linking structure. Further, to improve a function of the resin particles whereby the resin particles serve as charging sites, it is preferable that the resin of the resin particles can quickly charge a toner. The particles of such a resin are preferably those of a nitrogen-containing resin such as a nylon resin, an amino resin, or a melamine resin.

The resin particles can be produced by a method in which granulated resin particles are produced by polymerization such as emulsion polymerization or suspension polymerization, a method in which resin particles are produced by cross-linking at least one monomer and/or at least one oligomer dispersed in a solvent to granulate the product; or a method in which resin particles are produced by mixing and reacting at least one low molecular weight component and a cross-linking agent by melting and kneading, and by classifying the product to a predetermined particle size with air blow or mechanical force.

The volume average particle diameter of the resin particles is preferably about 0.1 to about 2.0 μm and more preferably about 0.2 to about 1.0 μm. If it is smaller than about 0.1 μm, dispersibility of the particles in the coating resin layer is poor. On the other hand, if it is larger than about 2 μm, the particles easily drop off the coating resin layer and therefore, a stable charging property cannot be obtained in some cases. A method for measuring the volume average particle diameter of the resin particles is the same as a method for measuring the volume average particle diameter of the cores.

The content of the resin particles in the coating layer is preferably about 1 to about 50% by volume, more preferably about 1 to about 30% by volume, and even more preferably about 1 to about 20% by volume. If the content of the resin particles in the coating layer is less than about 1% by volume, the effect of the resin particles may not be exhibited. If it exceeds about 50% by volume, the resin particles easily drop off the coating resin layer and a stable charging property cannot be obtained in some cases.

The coating layer may also contain electrically conductive powder dispersed therein.

Examples of the material of the electrically conductive powder include metals such as gold, silver, and copper; carbon black; metal oxides such as titanium oxide, magnesium oxide, zinc oxide, and aluminum oxide; calcium carbonate; aluminum borate; potassium titanate, and calcium titanate; and powder in which titanium oxide, zinc oxide, barium sulfate, aluminum borate, and potassium titanate powders are coated with tin oxide, carbon black or a metal. One of these may be used alone or two or more kinds of them may be used together. When metal oxide powder is used as the conductive powder, the degree of dependency of charging property on the environment can be lowered. Titanium oxide is particularly preferable.

The powders of those materials are preferably treated with a coupling agent. In particular, metal oxide treated with a coupling agent is preferable and titanium oxide treated with a coupling agent is more preferable. The electrically conductive powder treated with a coupling agent can be obtained by dispersing untreated electrically conductive powder in a solvent such as toluene, mixing and treating the powder dispersed with a coupling agent, and then drying the powder at a reduced pressure.

Further, the electrically conductive powder treated with a coupling agent may be pulverized by a pulverizer, if necessary, to remove agglomerates. Examples of the pulverizer include those conventionally known such as a pin mill, a disk mill, a hummer mill, a centrifugation-type mill, a roller mill, and a jet mill. A jet mill is particularly preferable. The coupling agent may be a conventionally known one such as a silane coupling agent, a titanium coupling agent, an aluminum coupling agent, or a zirconium coupling agent.

Among them, conductive powder treated with a silane coupling agent, particularly methyltrimethoxysilane, is effective for environmental stability of charging property.

The volume average particle diameter of the electrically conductive powder is preferably about 0.5 μm or smaller, more preferably about 0.05 to about 0.45 μm, and even more preferably about 0.05 to about 0.35 μm. A method for measuring the volume average particle diameter of the electrically conductive powder may be based on the above-described method for measuring the volume average particle diameter of the core.

If the volume average particle diameter of the electrically conductive powder exceeds about 0.5 μm, the powder easily drops off the coating resin layer and a stable charging property cannot be obtained in some cases.

The volume electric resistance of the electrically conductive powder is preferably about 10¹Ω·cm to about 10¹¹ Ω·cm and more preferably about 10³ Ω·cm to about 10⁹ Ω·cm. In this specification, the volume electric resistance of the electrically conductive powder is a value measured by the following method.

An electrically conductive powder is packed in a container having a cross sectional area of 2×10⁻⁴ m² at an ordinary temperature at an ordinary humidity to form a layer of the powder having a thickness of about 1 mm and a load of 1×10⁴ Kg/m² is then applied to the layer with an metallic member. A voltage necessary to generate an electric field of 10⁶ V/m is applied between the metallic member and an electrode on the bottom surface of the container and the value calculated from the current and voltage values at that time is defined as a volume electric resistance.

The content of the electrically conductive powder contained in the coating resin layer is generally about 1 to about 80% by volume, preferably about 5 to about 50% by volume, more preferably about 2 to about 20% by volume, and even more preferably about 3 to about 10% by volume.

A method for forming a coating layer on the surface of the core of each carrier particle may be an immersion method in which the carrier cores are immersed in a solution for forming a coating layer containing the above-mentioned resin, and a solvent and, if necessary, the electrically conductive material, a spray method in which a solution for forming a coating layer containing the resin, and a solvent and, if necessary, the electrically conductive material is sprayed to the surface of each of carrier cores, a fluidized bed method in which a solution for forming a coating layer containing the resin, and a solvent and, if necessary, the electrically conductive material is sprayed to the surface of each of carrier cores which are being fluidized with a fluidization air, or a kneader coater method in which a solution for forming a coating layer containing the resin, and a solvent and, if necessary, the electrically conductive material is mixed with carrier cores and the solvent is removed in a kneader coater.

The solvent of the solution for forming a coating layer needs to dissolve the resin therein but otherwise it is not particularly limited. Examples thereof include aromatic hydrocarbons such as toluene and xylene; ketones such as acetone and methyl ethyl ketone; and ethers such as tetrahydrofuran and dioxane.

The average thickness of the coating layer is preferably about 0.1 μm to about 10 μm, more preferably about 0.1 μm to about 3.0 μm, and even more preferably about 0.1 μm to about 1.0 μm. If the average thickness of the coating layer is thinner than about 0.1 μm, the coating layer undesirably peels off due to long time use of the carrier and the resistance of the carrier then decreases. If the average thickness exceeds about 10 μm, it takes a long time to cause the charging amount of a toner to reach a saturated charging amount.

The density (true specific gravity) of the carrier of the first embodiment whose core is coated with a resin is preferably about 3.0 to about 8.0 g/cm³, more preferably about 3.5 to about 7.0 g/cm³, and even more preferably about 4.0 to about 6.0 g/cm³. If the density is lower than about 3.0 g/cm³, fluidity of the carrier is close to fluidity of a toner and the carrier has a deteriorated charge supply capability. If the density is higher than about 8.0 g/cm³, fluidity of the carrier is poor and the total energy amount tends to exceed the upper limit value. A method for measuring the density of the carrier is the same as the method for measuring the density of the core of the carrier.

The shape factor SF1, defined by the following equation (1), of the carrier of the first embodiment is preferably about 130 or lower and more preferably about 120 or lower.

The closer to 100 the shape factor SF1 is, the more completely spherical the carrier particle is. As the shape factor of the carrier increases, the number of collision between carrier particles due to their shape strain becomes high and fluidity of the carrier deteriorates. Therefore, if the shape factor SF1 exceeds 130, the total energy amount tends to be so high as to exceed the upper limit.

shape factor SF1=(ML²/A)×(π/4)×100 Equation (1)

In Equation (1), ML means the absolutely maximum length of a carrier particle, and A means the projected area of the carrier particle.

The average of shape factors SF1 is obtained by capturing an optically microscopic image, which is obtained by magnifying each of 50 or more carrier particles 250 times, into an image analyzer (LUZEX III manufactured by NIRECO Corp.), obtaining the maximum length and the projected area of each image, calculating SF1 of each particle from the measured maximum length and projected area, and averaging the calculated SF1 values.

The saturation magnetization of the carrier of the first embodiment is preferably about 40 emu/g or higher and more preferably about 50 emu/g or higher.

For measurement of magnetic characteristics, a sample-vibrating-type magnetism measurement apparatus VSMP 10-15 (manufactured by Toei Kogyo Co.) is used. A measurement sample is packed in a cell having an inner diameter of 7 mm and a height of 5 mm, which cell is set in the apparatus. The measurement is carried out by applying a magnetic field to the sample and conducting sweeping up to 1000 Oe. Next, the applied magnetic field is weakened and a hysteresis curve is drawn on recording paper. Saturation magnetization, residual magnetization, and coercive force are obtained from the data of the drawn curve. In this invention, the saturation magnetization is magnetization measured under a magnetic field of 1000 Oe.

The volume electric resistance of the carrier is preferably controlled in the range of about 1×10⁸ to about 1×10¹⁴ Ω·cm, more preferably in the range of about 1×10⁸ to about 1×10¹³ Ω·cm, and even more preferably in the range of about 1×10⁸ to about 1×10¹² Ω·cm.

If the volume electric resistance of the carrier exceeds about 1×10¹⁴ Ω·cm, the resistance is high and it is difficult for the carrier to work as a development electrode at the time of development. For that, edge effect undesirably appears in an image, especially solid image portions, and reproducibility of solid portions deteriorates. On the other hand, if the volume electric resistance is lower than about 1×10⁸ Ω·cm, the resistance is low. Therefore, when the concentration of the toner in a developer decreases, a development roll gives the carrier an electric charge and the carrier itself undesirably migrates to a latent image.

The volume electric resistance (Ω·cm) of the carrier is measured as follows. The measurement environment is controlled so that temperature is 20° C. and humidity is 50% RH.

A carrier, which is a measurement object, is flatly placed on the surface of a circular jig having an electrode plate with an area of 20 cm² to form a carrier layer having a thickness of about 1 to about 3 mm. Another electrode plate having an area of 20 cm² is placed on the carrier layer so that the two electrode plates sandwich the carrier layer. A load of 4 kg is applied to the electrode plate placed on the carrier layer to eliminate voids among the carrier particles, and the thickness (cm) of the carrier layer is then measured. Both of the electrode plate on the carrier layer and that under the carrier layer are electrically connected to an electrometer and a high voltage electric power generation apparatus. A high voltage is applied to both electrode plates so as to generate an electric field of 10^{3.8} V/cm and the electric current value (A) at that time is read. From these data, the volume electric resistance (Ω·cm) of the carrier is calculated in accordance with the following equation (2).

R=E×20/(I−I₀)/L Equation (2)

In the equation, R denotes the volume electric resistance (Ω·cm) of a carrier; E is applied voltage (V); I is a current value (A); I₀ is the current value (A) when the value of applied voltage (V) is 0; and L is the thickness (cm) of a carrier layer. The coefficient, 20, is the area (cm²) of each electrode plate.

### —Carrier of Second Embodiment (Carrier Having Magnetic Powder-Dispersed Particle as Core)—

In the carrier of the second embodiment, the core is a magnetic powder-dispersed particle in which magnetic powder is dispersed in a resin.

The material of the magnetic powder can be the same as that of the aforementioned magnetic particles. Among them, the material is preferably iron oxide. Iron oxide powder (particles) is advantageous in terms of characteristic stability and low toxicity.

One kind of magnetic powder can be used alone or two or more kinds of magnetic powders may be used together.

The particle diameter of the magnetic powder is preferably about 0.01 to about 1 μm, more preferably about 0.03 to about 0.5 μm, and even more preferably about 0.05 to about 0.35 μm. If the particle diameter of the magnetic powder is smaller than about 0.01 μm, the saturation magnetization may lower or the viscosity of a composition (a monomer mixture) may increase and it may be impossible to obtain carrier particles having a uniform size. On the other hand, if the particle diameter of the magnetic powder exceeds about 1 μm, homogenous magnetic powder-dispersed particles cannot be obtained in some cases.

The content of the magnetic powder in the magnetic powder-dispersed particles is preferably about 30% by mass to about 95% by mass, more preferably about 45% by mass to about 90% by mass, and even more preferably about 60% by mass to about 90% by mass. If the content is lower than about 30% by mass, scattering of the magnetic material-dispersed carrier may occur. If the content exceeds about 95% by mass, the ear formed by the magnetic material-dispersed carrier is hard and is easy to break.

Examples of the resin (matrix) contained in the magnetic powder-dispersed particles include cross-linked styrene resins, acrylic resins, styrene-acrylic copolymer resins, phenol resins, urea resins, polyamide resins, and polyimide resins.

The magnetic powder-dispersed particles used in the invention may contain other components as well as the matrix and the magnetic powder, depending of the purpose thereof. Examples of other components include a charge control agent and fluorine-containing particles.

As for the particle diameter distribution of the magnetic powder-dispersed particles, the ratio of the volume particle diameter D_{84V} to the volume average particle diameter D_{50V} is preferably 1.20 or lower and more preferably 1.15 or lower. The ratio of the number average particle diameter D_{50P} to the number particle diameter D_{16P} is 1.25 or lower and more preferably 1.20 or lower.

A method of producing the magnetic powder-dispersed particles may be a melting and kneading method in which magnetic powder and an insulating resin such as a styrene-acrylic resin are melted and kneaded by a Banbury mixer or a kneader, the resultant mixture is cooled down and pulverized, and the resultant particles are classified (Japanese Patent Application Publication (JP-B) Nos. 59-24416 and 8-3679); a suspension polymerization method in which at least one monomer of a binder resin and magnetic powder are dispersed in a solvent and the monomer is polymerized in the resultant suspension (JP-A No. 5-100493, etc.); or a spray drying method in which a dispersion liquid obtained by dispersing magnetic powder in a resin solution is sprayed and dried.

All of the melting and kneading method, the suspension polymerization method, and the spray drying method include dispersing magnetic powder prepared in advance in a resin solution.

When the magnetic powder-dispersed particles are produced by a melting and kneading method, a centrifugation-type classifier, an inertia classifier, or a sieve may be employed to obtain particles having a desired particle size distribution.

When magnetic powder-dispersed particles having a desired particle size distribution are produced by a suspension polymerization method, it is very important to adjust the diameters of dispersion particles. For this, it is essential to adjust temperature at the time of dispersion, the amount and type of a surfactant, and the speed and duration of stirring. These control factors may be combined to adjust particles.

When magnetic powder-dispersed particles having a desired particle size distribution are produced by a spray drying method, it is important to adjust spraying and drying conditions. For example, since the size of the magnetic powder-dispersed particles is controlled by adjusting the size of droplets, it is essential that the size of the droplets is controlled by adjusting the pressure of a jetting nozzle and/or the rotation speed of a turntable or that the state of carrier surface is controlled by adjusting drying conditions.

The volume average particle diameter of the core in the carrier of the second embodiment is preferably in the range of about 10 to about 500 μm, more preferably in the range of about 30 to about 150 μm, and even more preferably in the range of about 30 to about 100 μm. If the volume average particle diameter is smaller than about 10 μm, the carrier undesirably easily migrates to a photoconductor and productivity of such core particles deteriorates. If the volume average particle diameter exceeds about 500 μm, streaks of the carrier so-called a brush mark appears in an image and the image has a rough surface impression.

A method of measuring the volume average particle diameter of the core is the same as that in the case where the core is a magnetic particle.

The density (true specific gravity) of the core in the carrier of the second embodiment is preferably about 2.0 to about 5.0 g/cm³, more preferably about 2.5 to about 4.5 g/cm³, and even more preferably about 3.0 to about 4.0 g/cm³. If the density is lower than about 2.0 g/cm³, fluidity of the carrier is close to fluidity of a toner, and the carrier has a deteriorated charge supply capability. If the density is higher than about 5.0 g/cm³, fluidity of the carrier is poor and the total energy amount tends to exceed the upper limit value. A method of measuring the density of the core is the same as that in the case of the carrier of the first embodiment.

The material(s) of the coating layer formed on the surface of each of the magnetic powder-dispersed particles can be the same as that or those of the coating layer formed on the surface of each of the magnetic particles. Typical examples of the material of the coating layer in the second embodiment can be the same as in the first embodiment. A method of forming the coating layer in the second embodiment is also the same as in the case of the coating layer on each of the magnetic particles.

The density (true specific gravity) of the carrier of the second embodiment containing the magnetic powder-dispersed particles and the coating layer formed on the surface of each of the magnetic powder-dispersed particles is preferably about 2.0 to about 5.0 g/cm³, more preferably about 2.5 to about 4.5 g/cm³, and even more preferably about 3.0 to about 4.0 g/cm³. If the density is lower than about 2.0 g/cm³, fluidity of the carrier is close to fluidity of a toner, and the carrier has a deteriorated charge supply capability. If the density is higher than about 5.0 g/cm³, fluidity of the carrier is poor and the total energy amount tends to exceed the upper limit value.

The average thickness of the coating layer on the surface of each of the magnetic powder-dispersed particles is preferably about 0.1 μm to about 10 μM, more preferably about 0.1 μm to about 3.0 μm, and even more preferably about 0.1 μm to about 1.0 μm. If the average thickness of the resin coating layer is thinner than about 0.1 μm, the coating layer undesirably peels off due to long time use of the carrier and the resistance of the carrier then decreases. If the average thickness exceeds about 10 μm, it takes a long time to cause the charging amount of a toner to reach a saturated charging amount.

The shape factor SF1, defined by the aforementioned equation (1), of the carrier of the second embodiment is preferably about 150 or lower and more preferably about 130 or lower. The shape factor SF1 is calculated in the same manner as in the first embodiment.

The saturation magnetization of the carrier of the second embodiment is preferably about 30 emu/g or higher, more preferably about 40 emu/g or higher, and even more preferably about 50 emu/g or higher.

A method of measuring the magnetic property is the same as that in the first embodiment.

The volume electric resistance of the carrier is preferably controlled in the range of about 1×10⁷ to about 1×10¹⁴ Ω·cm, more preferably in the range of about 1×10⁸ to about 1×10¹³ Ω·cm, and even more preferably in the range of about 1×10⁸ to about 1×10¹² Ω·cm.

If the volume electric resistance of the carrier exceeds about 1×10¹⁴ Ω·cm, the resistance of the carrier is high and it is difficult for the carrier to work as a development electrode at the time of development. For that, edge effect appears in an image, especially solid image portions and reproducibility of solid portions deteriorates. On the other hand, if the volume electric resistance is lower than about 1×10⁷ Ω·cm, the resistance of the carrier is low. Therefore, when the concentration of the toner in a developer decreases, a development roll gives the carrier an electric charge and the carrier itself undesirably migrates to a latent image.

A method for measuring the volume electric resistance of the carrier in the second embodiment is the same as that of the carrier in the first embodiment.

Next, a toner will be described.

A toner for electrostatic latent image development of the invention (hereinafter, simply referred to as toner in some cases) contains a binder resin and a coloring agent and has, in the second and seventh aspects, an average shape factor SF1 of 140 or lower. It is preferable that the toner has toner mother particles and an external additive added to the surfaces of the toner mother particles.

Herein, the shape factor SF1 in the invention is defined by the following equation (1).

SF1=10033 π×ML²/4A Equation (1)

In equation (1), SF1 denotes a shape factor; ML denotes the absolutely maximum length of a particle; and A denotes the projected area of the particle. The shape factor SF1 is 100 when the particle is completely spherical. The more significant the degree of strain of the particle is, the more the shape factor, which is more than 100, is.

Preferably, each of the toner mother particles is as close to a sphere as possible in order to obtain a developer capable of decreasing stirring stress in a developing unit. In the second and seventh aspects, it is necessary that the average shape factor SF1 of the toner mother particles is about 140 or lower. The average shape factor SF1 is preferably about 110 to about 138 and more preferably about 120 to about 135. If the average shape factor SF1 exceeds about 140, such straining toner particles undesirably promote peeling of the resin coating layer on the carrier.

The average shape factor SF1 is obtained by capturing an optically microscopic image which is obtained by magnifying each of 50 or more carrier particles 250 times, into an image analyzer (LUZEX III manufactured by NIRECO Corp.), obtaining the maximum length and the projected area of each image, calculating SF1 of each particle from the measured maximum length and projected area, and averaging the calculated SF1 values.

Regarding the toner particle size distribution index, the volume average particle size distribution index GSDv is preferably about 1.30 or smaller, and the number average particle size distribution index GSDp is preferably about 1.38 or smaller, and the ratio GSDv/GSDp of the volume average particle size distribution index GSDv to the number average particle size distribution index GSDp is preferably about 0.95 or higher.

If the volume average particle size distribution index GSDv exceeds about 1.30, or the number average particle size distribution index GSDp exceeds about 1.38, the resultant image has a decreased resolution. In the case where the ratio GSDv/GSDp is lower than about 0.95, chargeability of the toner decreases and image defects such as scattering of the toner and fogging occur in some cases.

The volume average particle diameter and the particle size distribution indices can be defined as follows. When the whole particle size range of the particle size distribution measured by COULTER COUNTER TAIL manufactured by BECKMAN COULTER is divided into several size ranges (channels) and a volume cumulative distribution curve is drawn from the smallest range, the particle diameters at cumulative counts of 16%, 50% and 84% are defined as D_{10V}, D_{50V}, and D_{84V}, respectively. The volume average particle diameter D_{50V} is defined as the volume average particle diameter. Similarly, when a number cumulative distribution curve is drawn from the smallest range, the particle diameters at cumulative counts of 16%, 50% and 84% are defined as D_{16P}, D_{50P}, and D_{84P}, respectively. The value of (D_{84V}/D_{16V})^{1/2} is defined as the volume particle size distribution index GSDv and the value of (D_{84P}/D_{16P})^{1/2} is defined as the number average particle size distribution index GSDp.

The measurement is carried out after the toner is dispersed in an aqueous electrolytic solution (an aqueous Isoton solution) for 30 seconds or longer with ultrasonic waves.

Practical measurement is as follows. 0.5 to 50 mg of a measurement sample is added to two milliliters of an aqueous solution containing 5% by mass of a surfactant or a dispersant, preferably sodium alkylbenzensulfonate. The resultant is added to 100 to 150 ml of the above-mentioned electrolytic solution. The resultant suspension in which the sample is suspended in the electrolytic solution is stirred for about 1 minute with an ultrasonic dispersing apparatus. The particle size distribution of the sample is measured with COULTER COUNTER TA-II and an aperture having an aperture diameter of 100 μm, and the volume average particle diameter is calculated in the above-described manner. The number of the particles used in the measurement is 50,000.

### (1) Toner Composition

Hereinafter, the components of the toner used in the invention will be described.

### 1) Binder Resin

Examples of the binder resin include homopolymers and copolymers of the following monomer(s): monoolefins such as ethylene, propylene, butylene, and isoprene; vinyl esters such as vinyl acetate, vinyl propionate, vinyl benzoate, and vinyl butyrate; α-methylene aliphatic monocarboxylic acid esters such as methyl acrylate, phenyl acrylate, octyl acrylate, methyl methacrylate, ethyl methacrylate, butyl methacrylate, and dodecyl methacrylate; vinyl ethers such as vinyl methyl ether, vinyl ethyl ether, and vinyl butyl ether; and vinyl ketones such as vinyl methyl ketone, vinyl hexyl ketone, and vinyl isopropenyl ketone. Among them, the binder resin is typically polystyrene, styrene-acrylic acid copolymer, styrene-butadiene copolymer, styrene-maleic anhydride copolymer, or polypropylene. The binder resin may also be polyester, polyurethane, an epoxy resin, a silicone resin, polyamide, or modified rosin.

In the second and seventh aspects, the binder resin of the toner can be a crystalline resin or an amorphous resin (non-crystalline resin). The both may be used together.

When the crystalline and amorphous resins may be used together, the ratio of the crystalline resin to the amorphous resin (non-crystalline resin) may be properly selected according to usage and purpose of the toner so as to obtain good balance among various properties such as fixability at a low temperature, fogging, or an image storability. Also, when the crystalline and amorphous resins may be used together, the ratio of the crystalline resin to all the binder resins is preferably within the range of about 20 to about 60% by weight. Further, a toner having a core-shell structure which includes a core layer containing a crystalline resin and a shell layer covering the core layer and containing an amorphous resin can be produced.

“Crystallinity” of the crystalline resin containable in the toner used in the invention means having a clear heat absorption peak rather than having stepwise heat absorption change in differential scanning calorimetry (DSC). Specifically, it means that the half breadth of a heat absorption peak in measuring at a programming rate of 10° C./min is within 10° C. Resins having a half breadth exceeding 10° C. or those having no clear heat absorption peak are non-crystalline resins (amorphous resins).

### —Non-Crystalline Resin—

The type of the non-crystalline resin is not particularly limited. A conventionally known resin material may be used as the non-crystalline resin. Examples thereof include homopolymers of the following compounds: styrenes such as styrene, p-chlorostyrene, and α-methylstyrene; vinyl group-containing esters such as methyl acrylate, ethyl acrylate, butyl acrylate, propyl acrylate, lauryl acrylate, ethylhexyl acrylate, methyl methacrylate, ethyl methacrylate, butyl methacrylate, propyl methacrylate, lauryl methacrylate, ethylhexyl methacrylate, vinyl acetate, and vinyl benzoate; carboxylic acid esters having a double bond such as methyl maleate, ethyl maleate, and butyl maleate; olefins such as ethylene, propylene, butylene, and butadiene; carboxylic acids having a double bond such as acrylic acid, methacrylic acid, and maleic acid. Also, copolymers of two or more of these compounds and mixtures of two or more of the homopolymers and the copolymers can be used as the non-crystalline resins.

Alternatively, the non-crystalline resin may be an epoxy resin, a polyester resin, a polyurethane resin, a polyamide resin, a cellulose resin, a polyether resin, a non-vinyl condensate resin, a mixture of at least one of these with the above-mentioned vinyl resin(s), or a graft polymer obtained by polymerizing at least one vinyl monomer in the presence of at least one of these resins.

At least one dissociable vinyl monomer may be used together with the monomer(s) of the non-crystalline resin in the invention at the time of polymerization in order to control the polymerization degree of the resin. Examples of the dissociable vinyl monomer include raw materials for high molecular acids and bases such as acrylic acid, methacrylic acid, maleic acid, cinnamic acid, fumaric acid, vinylsulfonic acid, ethylene imine, vinylpyridine, and vinylamine. In terms of easiness of polymer formation reaction, the dissociable vinyl monomer is preferably a high molecular weight acid. Above all, a dissociable vinyl monomer having a carboxyl group such as acrylic acid, methacrylic acid, maleic acid, cinnamic acid, or fumaric acid is preferable in terms of easy controllability of the polymerization degree and the glass transition temperature of the resin. The dissociable vinyl monomer is generally copolymerized with other monomer(s) at the time of polymerization of the non-crystalline resin.

The vinyl monomer can be emulsion-polymerized or seed-polymerized in the presence of an ionic surfactant to prepare a resin particle dispersion liquid. In the case of other resins which are soluble in oil and soluble in a solvent having a relatively low solubility in water, such a resin may be dissolved in the solvent, and the resulting solution can be mixed with a solution in which an ionic surfactant and/or high molecular electrolyte is dissolved in water. The resultant mixture can be stirred with a dispersing apparatus such as a homogenizer to disperse the resin particles in water. After that, the resultant resin particle dispersion liquid can be heated or treated at a reduced pressure to evaporate the solvent. Thus, a resin particle dispersion liquid can be obtained.

The weight-average molecular weight Mw of the non-crystalline resin is preferably in the range of about 10,000 to about 100,000, more preferably in the range of about 20,000 to about 50,000, and even more preferably in the range of about 20,000 to about 35,000. If Mw is less than about 10,000, plasticization of the resin occurs easily and occurrence of offset cannot be prevented in some cases. If Mw exceeds about 100,000, normal fixation cannot be carried out in some cases.

Measurement of Mw is carried out by gel permeation chromatography (GPC) under the following conditions. An apparatus manufactured by Tosho Corp., HLC-8120 GPC, SC-8020, is used as a GPC device, and two columns, TSK gel, SUPER HM-H (having an inner diameter of 6.0 mm and a length of 15 cm, and manufactured by Tosho Corp.), are used, and tetrahydrofuran (THF) is used as an eluent. The measurement conditions are as follows: the sample concentration of 0.5%, the flow speed of 0.6 ml/min., the sample injection amount of 10 μl, and the measurement temperature of 40° C. An IR detector is used in the measurement. A calibration curve is drawn on the basis of standardized polystyrene samples, or TSK standards (manufactured by Tosho Corp.) including the following 10 samples: A-500, F-1, F-10, F-80, F-380, A-2500, F-4, F-40, F-128, and F-700.

A chain transfer agent may be used at the time of polymerization of the non-crystalline rein containable in the toner of the invention. The type of the chain transfer agent is not particularly limited. A compound having a thiol moiety may be used as the chain transfer agent. The chain transfer agent is preferably an alkylmercaptan such as hexylmercaptan, heptylmercaptan, octylmercaptan, nonylmercaptan, decylmercaptan, or dodecyl mercaptan. The reason for this is that these compounds have a narrow molecular weight distribution and therefore improve storability of the toner at a high temperature.

The non-crystalline resin in the invention may be produced by radical polymerization of at least one polymerizable monomer.

A polymerization initiator can be used in the radical polymerization. The type of the polymerization initiator is not particularly limited. Examples thereof include peroxides such as hydrogen peroxide, acetyl peroxide, cumyl peroxide, tert-butyl peroxide, propionyl peroxide, benzoyl peroxide, chlorobenzoyl peroxide, dichlorobenzoyl peroxide, bromomethylbenzoyl peroxide, lauroyl peroxide, ammonium persulfate, sodium persulfate, potassium persulfate, diisopropyl peroxycarbonate, tetralin hydroperoxide, 1-phenyl-2-methylpropyl-1-hydroperoxide, tert-butyl triphenylperacetate hydroperoxide, tert-butyl performate, tert-butyl peracetate, tert-butyl perbenzoate, tert-butyl phenylperacetate, tert-butyl methoxyperacetate, and tert-butyl N-(3-tolyl)percarbamate; azo compounds such as 2,2′-azobispropane, 2,2′-dichloro-2,2′-azobispropane, 1,1′-azo(methylether) diacetate, 2,2′-azobis(2-amidinopropane) hydrochloride, 2,2′-azobis(2-amidinopropane) nitrate, 2,2′-azobisisobutane, 2,2′-azobisisobutylamide, 2,2′-azobisisobutyronitrile, 2,2′-azobis(methyl 2-methylpropionate), 2,2′-dichloro-2,2′-azobisbutane, 2,2′-azobis2-methylbutyronitrile, 2,2′-azobis(dimethyl isobutyrate), 1,1′-azobis(sodium 1-methylbutyronitrile-3-sulfonate), 2-(4-methylphenylazo)-2-methylmalonodinitrile, 4,4′-azobis(4-cyanovaleric acid), 3,5-dihydroxymethylphenylazo-2-methylmalonodinitrile, 2-(4-bromophenylazo)-2-allylmalonodinitrile, 2,2′-azobis2-methylvaleronitrile, 4,4′-azobis(dimethyl 4-cyanovalerate), 2,2′-azobis-2,4-dimethylvaleronitrile, 1,1′-azobiseyclohexanenitrile, 2,2′-azobis(2-propylbutyronitrile), 1,1′-azobis(1-chlorophenylethane), 1,1′-azobis(1-cyclohexanecarbonitrile), 1,1′-azobis(1-cycloheptanenitrile), 1,1′-azobis(1-phenylethane), 1,1′-azobiscumene, ethyl 4-nitrophenylazobenzylcyanoacetate, phenyl azodiphenylmethane, phenylazotriphenylmethane, 4-nitrophenylazotriphenylmethane, 1,1′-azobis(1,2-diphenylethane), poly(bisphenol A-4,4′-azobis-4-cyanopentanoate), and poly(tetraethylene glycol-2,2′-azobisisobutylate; 1,4-bis(pentaethylene)-2-tetrazene, and 1,4-dimethoxycarbonyl-1,4-diphenyl-2-tetrazene,

The molecular weight of the resin is mainly affected by the amount of the polymerization initiator in the polymerization. Generally, the molecular weight increases, as the amount of the polymerization initiator decreases.

The glass transition temperature of the non-crystalline resin in the invention is preferably in the range of about 45 to about 60° C. and more preferably in the range of about 50 to about 60° C. If the glass transition temperature is lower than about 45° C., the toner tends to cause blocking (phenomenon in which the toner particles agglomerate to form lumps) during storage or in a developing apparatus. On the other hand, if the glass transition temperature exceeds about 60° C., the fixation temperature of the toner is undesirably high.

### —Crystalline Resin—

The crystalline resin needs to have crystallinity and otherwise it is not limited. Specifically, the crystalline resin can be a crystalline polyester resin or a crystalline vinyl resin. In terms of the fixation property of the toner fixed on paper, chargeability and easy adjustment of the melting point of the resin within a desired range, the crystalline resin is preferably a crystalline polyester resin. The crystalline polyester resin is preferably a linear aliphatic one having a proper melting point.

The crystalline polyester resin is synthesized from an acid (dicarboxylic acid) component and an alcohol (diol) component. In the invention, copolymers obtained by copolymerizing a crystalline polyester main chain with 50 mass % or less of other component(s) are also included in the scope of the crystalline polyester resin.

The type of a method of producing the crystalline polyester resin is not particularly limited. The crystalline polyester resin can be prepared by a common polyester polymerization method in which the acid component is reacted with the alcohol component. Examples of such a method include a direct condensation polymerization method and an ester interchange method. The production method can be properly selected in accordance with the types of the monomers.

The production of the crystalline polyester resin can be carried out at a polymerization temperature within the range of about 180 to about 230° C. If necessary, the pressure of the reaction system may be reduced to remove water or alcohol generated at the time of condensation. When the monomers do not melt or are not compatible with each other at the reaction temperature, a solvent with a high boiling point may be added to the reaction system as a dissolution assisting agent so as to dissolve the monomers. The condensation polymerization reaction is carried out while the dissolution assisting agent is being distilled and removed. Where the raw materials include a monomer which is badly compatible with the other monomer(s) in the copolymerization reaction, the monomer with bad compatibility may be previously condensed with an acid or an alcohol to be condensation-polymerized and the resultant is then condensation-polymerized with a main component.

A catalyst can be used in producing the crystalline polyester resin. Examples thereof include compounds including an alkali metal such as sodium and lithium; those including an alkaline earth metal such as magnesium and calcium; those including such a metal as zinc, manganese, antimony, titanium, tin, zirconium, and germanium; phosphites, phosphates, and amine compounds.

Specific examples thereof include sodium acetate, sodium carbonate, lithium acetate, lithium carbonate, calcium acetate, calcium stearate, magnesium acetate, zinc acetate, zinc stearate, zinc naphthenate, zinc chloride, manganese acetate, manganese naphthenate, titanium tetraethoxide, titanium tetrapropoxide, titanium tetraisopropoxide, titanium tetrabutoxide, antimony trioxide, triphenylantimony, tributylantimony, tin formate, tin oxalate, tetraphenyltin, dibutyltin dichloride, dibutyltin oxide, diphenyltin oxide, zirconium tetrabutoxide, zirconium naphthenate, zirconyl carbonate, zirconyl acetate, zirconyl stearate, zirconyl octylate, germanium oxide, triphenylphosphite, tris(2,4-tert-butylphenyl)phosphite, ethyltriphenylphosphonium bromide, triethylamine, and triphenylamine.

Specific examples of the crystalline polyester resin thus produced and usable in the invention include poly(1,2-cyclopropenedimethylene isophthalate), poly(decamethylene adipate), poly(decamethylene azelate), poly(decamethylene oxalate), poly(decamethylene sebacate), poly(decamethylene succinate), poly(eicosamethylene malonate), polyethylene-p-(carbophenoxy)butyrate, polyethylene-p-(carbophenoxy)undecanoate, polyethylene-p-phenylene diacetate, polyethylene sebacate, polyethylene succinate, polyhexamethylene carbonate, polyhexamethylene p-(carbophenoxy) undecanoate, polyhexamethylene oxalate, polyhexamethylene sebacate, polyhexamethylene suberate, polyhexamethylene succinate, poly(4,4-isopropylidenediphenylene adipate), poly(4,4-isopropylidenediphenylene malonate, trans-poly(4,4-isopropylidenediphenylene-1-methylcyclopropane dicarboxylate), poly(nonamethylene azelate), poly(nonamethylene terephthalate), poly(octamethylene dodecanediate), poly(pentamethylene terephthalate), trans-poly(m-phenylenecyclopropane dicarboxylate), cis-poly(m-phenylenecyclopropane dicarboxylate), poly(tetramethylene carbonate), poly(tetramethylene-p-phenylene diacetate), poly(tetramethylene sebacate), poly(trimethylene decandioate), poly(trimethylene octadecanedioate), poly(trimethylene oxalate), poly(trimethylene undecanedioate), poly(p-xylene adipate), polyp-xylene azelate), poly(p-xylene sebacate), poly(diethylene glycol terephthalate), cis-poly[1,4-(2-butene) sebacate], and polycaprolactone.

Copolymers of at least two of the ester monomers of the above polymers, and copolymers of at least one of the ester monomers and at least one other copolymerizable monomer may also be used as the crystalline polyester resins.

The melting point of the crystalline resin in the invention is preferably about 40° C. or higher and more preferably about 60° C. or higher. The upper limit of the melting point is preferably about 100° C. or lower and more preferably about 90° C. or lower. In particular, the melting point of the crystalline resin is preferably in the range of about 60 to about 95° C. for fixation at a low temperature.

If the melting point of the crystalline resin is lower than about 40° C., the toner may cause blocking during storage or usage thereof. If the melting point of the crystalline resin is higher than about 100° C., the toner cannot be well fixed at a low temperature.

The melting point of the crystalline resin in the invention can be measured with the aforementioned differential scanning calorimeter. Specifically, the melting point is a melting peak temperature in differential thermal analysis measurement carried out on the basis of ASTM D3418-8 within the range from room temperature to 150° C. at a programming rate of 10° C./min. When plural melting peaks appears in the measurement, the maximum peak temperature is regarded as the melting point.

The molecular weight of the crystalline resin is not particularly limited, however the weight-average molecular weight Mw is preferably about 8,000 to about 80,000, more preferably about 10,000 to about 50,000, and even more preferably about 15,000 to about 30,000. If the weight-average molecular weight of the crystalline resin is smaller than about 8,000, fixed images may have insufficient strength and the toner may break during stirring in a developing unit. On the other hand, if the weight-average molecular weight of the crystalline resin is higher than about 80,000, the fixation temperature tends to be high.

The molecular weight of the crystalline resin can be measured in the same manner as that of the non-crystalline resin.

It is preferable that the non-crystalline resin is moderately compatible with the crystalline resin in the toner of the invention. If the non-crystalline resin is completely compatible with the crystalline resin, the toner viscosity is so low at the time of melting that hot-offset resistance of the toner may deteriorate. If the non-crystalline resin is never compatible with the crystalline resin, the crystalline resin cannot penetrate the toner inside and localizes on the surface of the toner, which may give adverse effects on the charging, powdering, and fixation properties of the toner.

### 2) Coloring Agent

The Coloring agent in the invention may be a conventionally known organic or inorganic pigment or dye, or an oil-soluble dye.

Examples thereof include C.I. Pigment Red 48:1, C.I. Pigment Red 57:1, C.I. Pigment Red 122, C.I. Pigment Yellow 17, C.I. Pigment Yellow 97, C.I. Pigment Yellow 12, C.I. Pigment Yellow 180, C.I. Pigment Yellow 185, C.I. Pigment Blue 15:1, C.I. Pigment Blue 15:3, lamp black (C.I. No. 77266), Rose Bengal (C.I. NO. 45432), carbon black, nigrosine dye (C.I. No. 50415B), aniline blue, calco oil blue, chrome yellow, ultramarine blue, Du Pont Oil Red, quinoline yellow, methylene blue chloride, phthalocyanine blue, malachite green oxalate, metal complex dyes, derivatives of the metal complex dyes, and mixtures thereof.

Other examples thereof include various kinds of metal oxides such as silica, aluminum oxide, magnetite and various kinds of ferrites, cupric oxide, nickel oxide, zinc oxide, zirconium oxide, titanium oxide, and magnesium oxide, and mixtures thereof. The coloring agent may be selected in consideration of the hue angle, chroma, luminosity, weather resistance, OHP transparency, and dispersibility in the toner.

Although the content of the coloring agent depends on the toner particle diameter and the development amount of the toner, the content is preferably in the range of about 1 to about 50 parts by mass and more preferably in the range of about 2 to about 25 parts by mass with respect to 100 parts by mass of the binder resin.

One of these coloring agents may be used alone or two or more of these can be used together or used as a solid solution. The coloring agent may be dispersed in the binder resin by a conventional method. In the method, a media-utilizing dispersing apparatus or a high pressure counter-collision-type dispersing apparatus such as a rotary shear-type homogenizer, a ball mill, a sand mill, or an attritor may be preferably used.

In the case where the coloring agent is used in an emulsion agglomeration method, the coloring agent is dispersed in a water-based system including a polar surfactant with a homogenizer.

### 3) External Additive

In the invention, it is preferable to add an external additive to the surfaces of toner mother particles in order to improve transferability, fluidity, cleaning property, and charge controllability of the toner, particularly fluidity. The external additive is inorganic particles adhering to the surface of each of the toner mother particles.

Examples of the material of the inorganic particles include SiO₂, TiO₂, Ti(OH)₂, Al₂O₃, CuO, ZnO, SnO₂, CeO₂, Fe₂O₃, MgO, BaO, CaO, K₂O, Na₂O, ZrO₂, CaO—SiO₂, K₂O—(TiO₂)n (n is an integer of 1 to 4), Al₂O₃-2SiO₂, CaCO₃, MgCO₃, BaSO₄, and MgSO₄. Above all, the inorganic particles are preferably silica particles or titania particles since they can well improve fluidity of the toner.

The volume average particle diameter of the external additive in the invention is preferably about 10 to about 40 nm, more preferably about 12 to about 35 nm, and most preferably about 15 to about 30 nm. If the volume average particle diameter of the external additive is smaller than about 10 nm, the agent sinks in the toner surface portion and does not contribute to fluidity of the toner. On the other hand, if the volume average diameter exceeds about 40 nm, the agent easily separates from the toner and does not contribute to fluidity of the toner and the free agent undesirably adheres to the carrier surface.

The volume average particle diameter of the external additive can be obtained as follows. The particle size distribution of the external additive is measured with a laser diffraction-type particle size distribution analyzer LA-700 (manufactured by Horiba, Ltd.). The whole particle size range of the measured particle size distribution is divided into several size ranges (channels) and a volume cumulative distribution curve is drawn from the smallest range. The particle diameter at a cumulative count of 50% is defined as the volume average particle diameter D_{50V}.

The external additive having a volume average particle diameter within the above range hardly sinks in the toner surface portion and hardly separates from the toner particles and therefore exhibits and retains good fluidity, when the toner including such an external additive is mixed with the carrier recited in the invention.

Regarding the addition amount of the external additive, the surface covering rate calculated in accordance with the following equation (3) is preferably about 10 to 100%, more preferably about 12 to about 80%, and even more preferably about 15 to about 60%.

$$Surface covering rate = \frac{\sqrt{3} {D}_{N} {ρ}_{N} X}{2 π \frac{{D}_{a}}{1000} {ρ}_{a}} \qquad Equation ( 3 )$$

In equation (3), D_{N} denotes the diameter (μm) of a toner mother particle; ρ_{N} denotes the density of the toner mother particle; Dₐ denotes the diameter (nm) of an external additive; ρₐ denotes the density of the external additive; and X denotes the addition amount (% by weight) of the external additive.

When plurality types of the external additives are added to the toner mother particles, the total of the respective surface covering rates is preferably 100% or less.

The surfaces of the inorganic particles serving as the external additive are preferably made hydrophobic. The treatment of making the external additive surface hydrophobic improves the powder fluidity of the toner and is also effective in decreasing the degree of dependency of chargeability of the toner on the environment and preventing carrier contamination. The treatment can be carried out by immersing the inorganic particles in an agent for providing hydrophobic property. The type of the agent is not particularly limited and the agent can be a silane coupling agent, a silicone oil, a titanate coupling agent, or an aluminum coupling agent. One of these may be used alone or two or more kinds of them may be used together. Above all, the agent is preferably a silane coupling agent.

The silane coupling agent can be any of chlorosilanes, alkoxysilanes, silazanes, and special silylating agents. Specific examples thereof include methyltrichlorosilane, dimethyldichlorosilane, trimethylchlorosilane, phenyltrichlorosilane, diphenyldichlorosilane, tetramethoxysilane, methyltrimethoxysilane, dimethyldimethoxysilane, phenyltrimethoxysilane, diphenyldimethoxysilane, tetraethoxysilane, methyltriethoxysilane, dimethyldiethoxysilane, phenyltriethoxysilane, diphenyldiethoxysilane, isobutyltriethoxysilane, decyltrimethoxysilane, hexamethyldisilazane, N,O-(bistrimethylsilyl)acetamide, N,N-(trimethylsilyl)urea, tert-butyldimethylchlorosilane, vinyltrichlorosilane, vinyltrimethoxysilane, vinyltriethoxysilane, γ-methacryloxypropyltrimethoxysilane, β-(3,4-epoxycyclohexyl)ethyltrimethoxysilane, γ-glycidoxypropyltrimethoxysilane, γ-glycidoxypropylmethyldiethoxysilane γ-mercaptopropyltrimethoxysilane, and γ-chloropropyltrimethoxysilane. The use amount of the agent depends on the type of the inorganic particles, and cannot be necessarily clearly defined. However, the amount is generally in the range of about 5 to about 50 parts by weight with respect to 100 parts by weight of the inorganic particles.

The degree of the hydrophobic property of the external additive which hydrophobic property is added by the above treatment is preferably about 40 to about 100%, more preferably about 50 to about 90%, and even more preferably about 60 to about 90%.

In the invention, the degree of hydrophobic property (M) is obtained as follows. 0.2 grams of particles are added to 50 cc of water and the resultant mixture is stirred with a stirrer. Thereafter, titration is conducted using methanol. Given the amount of methanol used to suspend all the particles in the solvent is T (cc), the degree of hydrophobic property is calculated in accordance with the following equation.

Degree of hydrophobic property (M)=[T/(50+T)]×100 (% by volume)

### 4) Other Components

The toner of the invention may contain other components such as an offset preventive agent or a releasing agent, if necessary.

Specific examples of the releasing agent usable in the invention include the following compounds.

The releasing agent can be wax. Examples thereof include vegetable waxes such as carnauba wax, cotton wax, Japan wax, and rice wax; animal waxes such as bee wax and lanoline; mineral waxes such as montan wax and derivatives thereof, and ozokerite and sercine; petroleum waxes such as paraffin and derivatives thereof, microcrystalline and derivatives thereof, and petrolactam. Alternatively, the releasing agent can be synthetic hydrocarbon wax such as Fisher-Tropsch wax or a derivative thereof, polyolefin wax including polyethylene wax, a synthetic wax of fatty acid amide, ester, ketone, ether, alcohol, or fatty acid such as 12-hydroxystearic acid amide, stearic acid amide, phthalic anhydride imide, or chlorinated hydrocarbon; or low molecular weight polypropylene or low molecular weight polyethylene. Examples of the derivative include oxides, polymers with a vinyl monomer, and graft-modified products.

Alternatively, the releasing agent may also be a crystalline polymer having a long alkyl group in the side chain(s) thereof. Examples of the crystalline polymer include homopolymers and copolymers of acrylates, such as poly(n-stearyl methacrylate), poly(n-lauryl methacrylate), and n-stearyl acrylate/ethyl methacrylate copolymer. Among them, the releasing agent is preferably petroleum wax or synthetic wax such as paraffin wax or microcrystalline wax.

The content of the releasing agent in the entire toner particles is preferably in the range of about 10 to about 40% by mass, more preferably in the range of about 10 to about 30% by mass, even more preferably in the range of about 15 to about 30% by mass, and most preferably in the range of about 15 to about 25% by mass. If the content of the releasing agent is about 10% by mass or higher, a sufficient releasing property can be ensured and occurrence of hot offset can be prevented. On the other hand, if the content is about 40% by mass or lower, exposure of the releasing agent on the toner surface can be prevented and good fluidity and chargeability of the toner can be obtained.

The toner in the invention may also contain a lubricant and/or a charge control agent, if necessary.

Examples of the lubricant include fatty acid amides such as ethylene bis(stearic acid amide) and oleic acid amide; and metal salts of fatty acids such as zinc stearate and calcium stearate.

The charge control agent is contained in the toner to improve and stabilize chargeability of the toner. The agent can be a conventionally used one such as a quaternary ammonium salt compound, a nigrosine compound, a dye containing a complex of aluminum, iron, or chromium, or a triphenylmethane pigment. In terms of control of the ionic strength which affects stability of agglomerating particles and suppression of wastewater pollution in the agglomerating, melting and fusing steps of toner production by an emulsion agglomeration method, which will be described later, it is preferable that the charge control agent is hard to dissolve in water.

In particular, the charge control agent is preferably one selected from the group consisting of those contained in a powder toner, such as metal salts of benzoic acid, metal salts of salicylic acid, metal salts of alkylsalicylic acid, metal salts of catechol, metal-containing bisazo dyes, tetraphenyl borate derivatives, quaternary ammonium salts, and alkylpyridinium salts, or is preferably a combination of two or more of these compounds.

When inorganic particles serving as the charge control agent are added to the toner in a wet manner, examples of the inorganic particles include those ordinarily used as an external additive added to the surfaces of toner particles, such as particles of silica, alumina, titania, calcium carbonate, magnesium carbonate, and tricalcium phosphate. In this case, the inorganic particles can be dispersed in a solvent in the presence of an ionic surfactant, a high molecular weight acid, or a high molecular weight base.

The charge control agent to be included in a color toner is preferably colorless or of light color to prevent adverse affects on the color tone of the toner. The charge control agent may be a conventionally employed one and is preferably an azo metal complex, or a metal complex or a metal salt of salicylic acid or alkylsalicylic acid.

Further, the toner may contain inorganic particles as an internal additive to make oil-less fixation easy. To obtain transparency on an OHP sheet, the inorganic particles preferably have a refractive index lower than that of the toner binder resin. If the refractive index is too high, the color of the toner may be turbid even in ordinary images. Specific examples of the material of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO—SiO₂, K₂O—(TiO₂)n, Al₂O₃-2SiO₂, CaCO₃, MgCO₃, BaSO₄, and MgSO₄.

Among these, the inorganic particles are preferably silica or titania particles. The silica particles may contain dehydrated silica, aluminum silicate, sodium silicate, and/or potassium silicate. The composition of the inorganic particles is preferably so adjusted as to have a refractive index of 1.5 or lower.

The surfaces of the inorganic particles may be made hydrophobic. The treatment of making the inorganic particle surface hydrophobic improves dispersibility of the inorganic particles in the toner. Moreover, when a portion of the inorganic particles to be present in the toner inside appears on the surface, the particles are effective in decreasing the degree of dependency of chargeability of the toner on the environment and preventing carrier contamination. The treatment can be carried out by immersing the inorganic particles in an agent for providing hydrophobic property. The type of the agent is not particularly limited and the agent can be a silane coupling agent, a silicone oil, a titanate coupling agent, or an aluminum coupling agent. One of these may be used alone or two or more kinds of them may be used together. Above all, the agent is preferably a silane coupling agent.

The use amount of the agent depends on the type of the inorganic particles, and cannot be necessarily clearly defined. However, the amount is generally in the range of about 5 to about 50 parts by weight with respect to 100 parts by weight of the inorganic particles.

The mother particles of the toner in the invention may have a core/shell structure. The type of the binder resin of the core portion is not particularly limited and the binder resin can be one of the aforementioned crystalline resins and non-crystalline resins, or a combination thereof. The type of the binder resin of the shell portion is not particularly limited, but the binder resin is preferably a non-crystalline resin. When the binder resins of the core and shell portions are non-crystalline resins, they may be the same or different.

### (2) Method of Producing Toner

In the first, third to sixth, eighth and ninth aspects, the type of a method of producing the toner is not particularly limited. In the second and seventh aspects, a method of producing the toner needs to prepare a toner having a shape factor SF1 within the above-described range but otherwise it is not particularly limited. The method can be a kneading and pulverizing method, a suspension polymerization method, a solution suspension method, or an emulsion-polymerization and agglomeration method. To produce toner having a proper shape factor and a proper particle diameter, a wet granulation method is preferably conducted. The wet granulation method may be a conventionally known melting suspension method, an emulsification and agglomeration method, or a solution suspension method. Among them, an emulsification and agglomeration method is preferably conducted.

In the kneading and pulverizing method, a binder resin, a coloring agent, a releasing agent, and other additives are kneaded, and the resultant mixture is pulverized, and the resultant particles are classified. The particles produced by the kneading and pulverizing method have a relatively wide particle size distribution and irregular shapes, and most of them have a shape factor SF1 exceeding 140. If the kneaded and pulverized toner particles are used, sharp portions of the toner particles cause the resin coating layer of the carrier to peel off. To avoid such a situation, in the invention, it is preferable that the particles produced by the kneading and pulverizing method are classified to obtain particles having a narrow particle size distribution and that the resultant particles are heated to make the shapes thereof spherical.

In the invention, a conventionally known method may be employed as the kneading and pulverizing method. The resultant particles may be classified with a gravity-employing classifier, a centrifugation-type classifier, an inertia classifier, or a sieve. The heat treatment may be carried out with a fluidized bed layer or a spray drier.

In the suspension polymerization method, a solution containing at least one polymerizable monomer of a binder resin, a coloring agent, and other additives is suspended in a water-based solvent and the monomer is polymerized in the resultant suspension.

In the solution suspension method, a solution containing a binder resin, a coloring agent, and other additives is suspended in a water-based solvent and the resulting suspension is then granulated.

In the emulsion-polymerization and agglomeration method, a resin particle dispersion liquid produced by emulsion-polymerization is mixed with a coloring agent dispersion liquid produced by dispersing a coloring agent in a solvent to form agglomerates with a size corresponding to a toner particle diameter, and the agglomerates are heated, fused and coalesced to form a toner. Therefore, the emulsion-polymerization and agglomeration method can easily provide a toner having a small particle diameter and a narrow particle size distribution, and can provide a toner having a smoothed surface and a controlled degree of sphericalness by controlling the conditions of the fusion and coalescence process in liquid, as compared with a kneading and pulverizing method.

### <Image Formation Method>

The image formation method of the invention preferably includes: electrically charging a latent image-holding member, exposing the charged latent image-holding member to light so as to form an electrostatic latent image thereon, developing the electrostatic latent image with a developer containing a toner and a carrier to form a toner image, and transferring the toner image from the latent image-holding member to a recording material. The carrier used for the image formation contains the above-mentioned carrier for electrostatic image development. The toner is the above-described.

Conventionally known techniques may be properly employed in the charging, exposing, developing, and transferring steps of the image foliation method of the invention. The image formation method of the invention can further include: cleaning the latent image-holding member and fixing the transferred toner image on the recording material after the transferring step.

In the developing step, it is preferable to provide a developer-carrying member (a so-called magnet roll) which faces the latent image-holding member, holds the developer on the surface thereof and is rotated to transport the developer to the latent image-holding member.

The peripheral speed of the developer-carrying member is preferably about 200 mm/sec to about 600 mm/sec and more preferably about 300 mm/sec to about 500 mm/sec. If the peripheral speed of the magnet roll is lower than about 200 mm/sec, this cannot satisfy recent requirements of high speed, and results in poor high density reproducibility. On the other hand, if the peripheral speed exceeds about 600 mm/sec, and if a developing unit including such a member has a compact size, the developing unit has insufficient mechanical strength and this causes a trimmer to strain, which leads to unevenness in the thickness or the like of the entire developer layer on the developer-carrying member, and deteriorated density reproducibility.

In the second and seventh aspects, it is preferable that the peripheral speed of the latent image-holding member and the ratio of the peripheral speed of the developer-carrying member to that of the latent image-holding member are about 100 to about 600 mm/sec and about 1.2 to about 2.0, respectively.

If the peripheral speed of the latent image-holding member is lower than about 100 mm/sec, this cannot satisfy recent requirements of high speed. On the other hand, if the peripheral speed exceeds about 600 mm/sec, a latent image on the latent image-holding member is developed before optical attenuation, which is caused by exposing the charged latent image-holding member to light and whereby a latent image is formed on the latent image-holding member, sufficiently occurs. Therefore, sufficient contrast cannot be obtained, resulting in formation of an image having a low resolution.

If the ratio of the peripheral speed of the developer-carrying member to that of the latent image-holding member is smaller than about 1.2, the time when a latent image on the latent image-holding member is developed with the developer becomes short. Therefore, in the case of a high density image, the amount of the toner used in the development becomes insufficient and an image having a decreased density is obtained. If the ratio is higher than about 2.0, the developer is brought into contact with the latent image-holding member for a sufficient time and the amount of the toner used in the development is sufficient. However, the relative speed of the developer-carrying member to the speed of the latent image-holding member is contrarily too fast, and therefore the developer scratches the latent image-holding member, and a disordered image is obtained.

### <Image Formation Apparatus>

The image formation apparatus of the invention preferably has a latent image-holding member (electrophotographic photoreceptor), a charging unit for electrically charging the latent image-holding member, an exposure unit for exposing the charged latent image-holding member to form an electrostatic latent image on the member, a developing unit for developing the electrostatic latent image with a developer to form a toner image on the member, and a transferring unit for transferring the toner image from the latent image-holding member to a recording material.

The image formation apparatus of the invention may further have a cleaning unit for cleaning the latent image-holding member after the transferring and charge-removing unit for removing the residual charge on the image-holding member after the transferring. The configurations of these units, that is, the electrophotographic photoreceptor, the charging unit, the exposure unit, the developing unit, the transferring unit, the cleaning unit, and the charge-removing unit are not particularly limited in the invention. These units may have any conventionally known configuration without restrictions.

The developing unit preferably has a stirrer for stirring the developer and a developer-carrying member (so-called magnet roll) for transporting the developer to the latent image-holding member.

### EXAMPLES

Hereinafter, the invention will be described with reference to Examples. However, the invention is not limited to these Examples.

### <Methods for Measuring Various Properties>

At first, methods for measuring the physical properties of carriers or the like used in Examples and Comparative Examples will be described.

### —Shape Factor—

Optically microscopic images of toner particles scattered on a slide glass are captured into an image analyzer (LUZEX III manufactured by NIRECO Corp.), and the maximum length and the projection area of each of 50 particles are measured, and the SF1 value of each particle is calculated in accordance with the aforementioned equation (1) and the measured maximum length and projection area, and the calculated SF1 values are averaged.

### —Volume Average Particle Diameter and Particle Size Distribution—

An apparatus for measuring volume average particle diameter and particle size distribution is a laser diffraction/scattering-type particle size distribution measurement apparatus (LS PARTICLE SIZE ANALYZER LS13 320 manufactured by BECKMAN COULTER).

The measurement method is carried out as follows. A measurement sample is added to two milliliters of an aqueous solution containing 5% by mass of a surfactant or a dispersant, preferably sodium alkylbenzensulfonate. The amount of the sample is 10 mg. The resultant is added to pure water. The amount of the pure water is 100 ml. The resultant suspension in which the sample is suspended is stirred for about one minute with an ultrasonic dispersing apparatus. The particle size distribution of the sample is measured at a pump speed of 80% with LS PARTICLE SIZE ANALYZER LS 13 320. Then, the volume average particle diameter, the particle size distribution at a coarse particle side, and the particle size distribution at a particle size of the sample are obtained.

In Examples 16 to 23 and Comparative Examples 16 to 21, COULTER COUNTER TA-II MODEL (manufactured by BECKMAN COULTER) is used as a volume average particle diameter measurement apparatus and ISOTON II (manufactured by BECKMAN COULTER) is used as an electrolytic solution. The measurement method is carried out as follows. A measurement sample is added to two milliliters of an aqueous solution containing 5% by mass of a surfactant or a dispersant, preferably sodium alkylbenzensulfonate. The amount of the sample is 0.5 to 50 mg. The resultant is added to the electrolytic solution. The amount of the electrolytic solution is 100 to 150 ml. The resultant suspension in which the sample is suspended in the electrolytic solution is stirred for about one minute with an ultrasonic dispersing apparatus. The particle size distribution of the sample is measured with COULTER COUNTER TA-II MODEL and an aperture having an aperture diameter of 100 μm, and the volume average particle diameter of the sample is calculated in the aforementioned manner. The number of particles used in the measurement is 50,000.

### —Measurement of Molecular Weight Distribution—

In Examples 1 to 15 and Comparative Examples 1 to 15, the molecular weight distribution of each of the resin of a toner and the coating resin of a carrier is measured under the following conditions.

An apparatus manufactured by Tosoh Corp., HLC-8120 GPC, SC-8020, is used as a GPC device, and two columns, TSK gel, SUPER HM-H (having an inner diameter of 6.0 mm and a length of 15 cm, and manufactured by Tosho Corp.), are used, and tetrahydrofuran (THF) is used as an eluent. The measurement conditions are as follows: the sample concentration of 0.5%, the flow speed of 0.6 ml/min., the sample injection amount of 10 μl, and the measurement temperature of 40° C. A calibration curve is drawn on the basis of the following 10 samples: A-500, F-1, F-10, F-80, F-380, A-2500, F-4, F-40, F-128, and F-700. The data collection intervals in the sample analysis are set to 300 ms.

### —Measurement of Density—

In Examples 9 to 15 and Comparative Examples 7 to 15, the density of the core of the carrier is measured by the aforementioned method.

### —Glass Transition Temperature—

In Examples 16 to 23 and Comparative Examples 16 to 21, glass transition temperature (Tg) is measured with a differential scanning calorimeter (DSC-50 manufactured by Shimadzu Corp.) at a programming rate of 3° C./min. The temperature at the intersection of the base line and the rising line in a heat absorption portion is defined as the glass transition temperature.

### —Weight-Average Molecular Weight and Number-Average Molecular Weight—

In Examples 16 to 23 and Comparative Examples 16 to 21, weight-average molecular weight Mw and number-average molecular weight Mn are measured by gel permeation chromatography (GPC). An apparatus manufactured by Tosoh Corp., HLC-8120 GPC, SC-8020 is used as the GPC device, and two columns, TSK gel, SUPER HM-H (having an inner diameter of 6.0 mm and a length of 15 cm, and manufactured by Tosho Corp.), are used, and tetrahydrofuran (THF) is used as an eluent. The measurement conditions are as follows: the sample concentration of 0.5%, the flow speed of 0.6 ml/min., the sample injection amount of 10 and the measurement temperature of 40° C. An IR detector is used in the measurement. A calibration curve is drawn on the basis of standardized polystyrene samples, or TSK standards (manufactured by Tosho Corp.) including the following 10 samples: A-500, F-1, F-10, F-80, F-380, A-2500, F-4, F-40, F-128, and F-700.

### —Acid Value of Resin—

In Examples 16 to 23 and Comparative Examples 16 to 21, the acid value (AV) of a resin is measured as follows. The basic operation is based on JIS K-0070-1992.

Each sample can be obtained by previously removing THF-insoluble components from a binder resin. 1.5 grams of a product obtained by pulverizing each sample is precisely taken, and put into a beaker having a volume of 300 ml. Hundred milliliters of a mixture of toluene and ethanol at a ratio of 4/1 is added to the beaker and the product is dissolved therein. Potentiometric titration of the resultant solution is carried out with a 0.1 ol/L KOH ethanol solution and an automatic titration apparatus GT-100 (Dia Instruments Co., Ltd.). The use amount of the KOH solution is denoted as A (ml). Potentiometric titration of a blank is simultaneously carried out and the use amount of the KOH solution at that time is denoted as B (ml). The acid value is calculated from these values according to the following equation. In the equation, w is the accurately measured weight of the sample and f is a factor for KOH. Acid value (mgKOH/g)={(A−B)×f×5.61}/w

### Example 1

Ferrite particles (including Cu—Zn and having a density of 4.5 g/cm³, a volume average particle diameter of 35 μm, and a shape factor SF1 of 125) are classified with an elbow-jet device (Product No. EJ-LABO manufactured by Nittetsu Mining Co., Ltd.) at cut points of 25 μm and 45 μm to remove powder and coarse powder and to obtain core particles to be coated.

Regarding the particle diameter distribution of the obtained core particles to be coated, the particle size distribution index at a coarse particle side (D_{84V}/D_{50V}) is 1.18, and the particle size distribution index at a particle size (D₅₀ₚ/D₁₆ₚ) is 1.20, and the volume average particle diameter is 37 μm, and the shape factor SF1 is 124.

Twenty parts by mass of a toluene solution (solid content of 15 parts by mass) of styrene-methyl methacrylate copolymer (weight-average molecular weight of 80,000) is added to 100 parts by mass of the core particles to be coated. The resultant mixture is stirred by a batch-type kneader having a capacity of 50 liters and a jacket for 10 minutes. The mixture, which is being stirred, is heated to a temperature of 120° C. or higher and kept at that temperature for 20 minutes. Then, the mixture, which is being stirred, is cooled down until the temperature thereof is decreased to 60° C. Thereafter, the resultant coated particles are taken out. The coated particles are classified three times with the elbow-jet device under the above-described conditions to remove powder and coarse powder. Thus, a carrier (1) is obtained.

Regarding the particle diameter distribution of the carrier (1), the particle size distribution index at a coarse particle side is 1.15, and the particle size distribution index at a particle size is 1.16, and the volume average particle diameter is 37 μm, and the shape factor SF1 is 123.

The total energy amount of the carrier (1) is measured with POWDER RHEOMETER FT4 (manufactured by Freeman Technology) in the above-described manner. The concrete measurement method is as follows.

At first, an auxiliary tool is attached to the upper side of a container having a capacity of 160 ml. The carrier (1) is put into the container to overflow the container. Next, the container charged with the carrier (1) is set in a measurement apparatus and a rotor manufactured by Freeman Technology, a propeller-type blade having a diameter of 48 mm and a width of 10 mm and shown in FIG. 3, is set above the container. Conditioning is repeated four times at a helix angle of −5.0° and a tip end speed of the rotor of 60 mm/s.

Subsequently, the carrier (1) sufficiently degassed by the conditioning is leveled at the top end of the container and the rotor is moved downward at a helix angle of −5.0° and a tip end speed of the rotor of 100 mm/s to the point which has a height of 10 mm from the bottom of the container (approach (migration) length of 70 mm). The integrated value of torque is obtained as the total energy amount. The total energy amount of the carrier (1) is 2400 mJ.

### Examples 2 to 4

Carriers (2) to (4) are produced in the same manner as in Example 1, except that the number of repeated times of the powder/coarse powder removal treatment conducted with the elbow-jet device to obtain a carrier coated with a resin is changed from three to a value within the range of 2 to 5. The total energy amount of each of the carriers (2) to (4) is shown in Table 1.

### Example 5

Ferrite particles (including Cu—Zn and having a density of 4.5 g/cm³, a volume average particle diameter of 35 μm, and a shape factor SF1 of 120) are classified with the elbow-jet device at cut points of 22 μm and 45 μm to remove powder and coarse powder and to obtain core particles to be coated.

Regarding the particle diameter distribution of the obtained core particles to be coated, the particle size distribution index at a coarse particle side is 1.18, and the particle size distribution index at a particle size is 1.20, and the volume average particle diameter is 37 μm, and the shape factor SF1 is 118.

Sixty parts by mass of a toluene solution (solid content of 5% by mass) of methyl methacrylate-perfluorohexyl acrylate copolymer (having a copolymerization rate of the former monomer to the latter monomer of 80/20, and a weight-average molecular weight of 50,000, and manufactured by Sanyo Chemical Industries Ltd.) and 10 parts by mass of a toluene solution (solid content of 15% by mass) of styrene-methyl methacrylate copolymer (weight-average molecular weight of 80,000) are added to 100 parts by mass of the core particles to be coated. The resultant mixture is stirred by a batch-type kneader having a capacity of 50 liters and a jacket for 10 minutes. The mixture, which is being stirred, is heated to a temperature of 120° C. or higher and kept at that temperature for 20 minutes. Then, the mixture, which is being stirred, is cooled down until the temperature thereof is decreased to 60° C. Thereafter, the resultant coated particles are taken out, and sifted with a sieve having a pore size of 75 μm so as to remove coarse particles. Thus, a carrier (5) is obtained. The total energy amount of the carrier (5) is shown in Table 1.

### Example 6

| | |
|---|---|
| Styrene-butyl acrylate copolymer (80/20) | 30 parts by mass |
| (Mw = 1.9 × 10⁵) | |
| Methyl methacrylate-perfluorohexyl acrylate | 10 parts by mass |
| copolymer | |
| Magnetite (EPT-1000 manufactured by Toda | 100 parts by mass |
| Kogyo Corp.) | |

The above components are melted and mixed by a pressurizing kneader, and pulverized and made spherical by a turbo-mill and a heat treatment apparatus. Further, the resultant particles are classified by the elbow-jet device four times at cut points of 22 μm and 45 μm to obtain a carrier (6).

Regarding the particle diameter distribution of the carrier (6), the particle size distribution index at a coarse particle side is 1.17, and the particle size distribution index at a particle size is 1.19, and the volume average particle diameter is 33 μm, and the shape factor SF1 is 110, and the density is 3.5 g/cm³. The total energy amount of the carrier (6) is shown in Table 1.

### Example 7

A carrier (7) is produced in the same manner as in Example 6, except that the number of repeated times of the classification treatment are changed to three. The total energy amount of the carrier (7) is shown in Table 1.

### Example 8

A carrier (8) is produced in the same manner as in Example 6, except that the amount of the styrene-butyl acrylate copolymer (80/20) is changed to 30 parts by mass and the amount of the methyl methacrylate-perfluorohexyl acrylate copolymer is changed to 20 parts by mass. The total energy amount of the carrier (8) is shown in Table 1.

### Comparative Example 11

Ferrite particles (including Cu—Zn and having a density of 4.5 g/cm³, a volume average particle diameter of 35 μm, and a shape factor SF1 of 125) are not classified. Twenty parts by mass of a toluene solution (solid content of 15 parts by mass) of styrene-methyl methacrylate copolymer (weight-average molecular weight of 80,000) is added to 100 parts by mass of the ferrite particles. The resultant mixture is stirred by a batch-type kneader having a capacity of 50 liters and a jacket for 10 minutes. The mixture, which is being stirred, is heated to a temperature of 120° C. or higher and kept at that temperature for 20 minutes. Then, the mixture, which is being stirred, is cooled down until the temperature thereof is decreased to 60° C. Thereafter, the resultant coated particles are taken out, and sifted with a sieve having a pore size of 75 μm so as to remove coarse particles. Thus, a carrier (9) is obtained.

The total energy amount of the carrier (9) is 3800 mJ.

### Comparative Examples 2 and 3

Carriers (10) and (11) are produced in the same manner as in Comparative Example 1, except that the sifting with the sieve having a pore size of 75 μm to remove coarse particles is replaced with once or two times of classification with the elbow-jet device to remove coarse and powders. The total energy amounts of the carriers (10) and (11) are shown in Table 2.

### Comparative Example 4

Ferrite particles (including Cu—Zn and having a density of 4.5 g/cm³, a volume average particle diameter of 35 μm, and a shape factor SF1 of 120) are classified with the elbow-jet device to remove powder and coarse powder and to obtain core particles to be coated. Regarding the particle diameter distribution of the obtained core particles to be coated, the particle size distribution index at a coarse particle side is 1.18, and the particle size distribution index at a particle size is 1.20, and the volume average particle diameter is 37 μm, and the shape factor SF1 is 109.

Sixty parts by mass of a toluene solution (solid content of 5% by mass) of perfluorohexyl methacrylate-methyl methacrylate copolymer (having a weight-average molecular weight of 50,000, and manufactured by Sanyo Chemical Industries Ltd.) and 10 parts by mass of a toluene solution (solid content of 15% by mass) of styrene-methyl methacrylate copolymer (weight-average molecular weight of 75,000) are added to 100 parts by mass of the core particles to be coated. The resultant mixture is stirred by a batch-type kneader having a capacity of 50 liters and a jacket for 10 minutes. The mixture, which is being stirred, is heated to a temperature of 120° C. or higher and kept at that temperature for 20 minutes. Then, the mixture, which is being stirred, is cooled down until the temperature thereof is decreased to 60° C. Thus, a carrier (12) is obtained. The total energy amount of the carrier (12) is shown in Table 2.

### Comparative Example 5

### Carrier of Example 1 of JP-A No. 2002-328493

A carrier (13) having a magnetic powder-dispersed particle as the core is produced in the same manner as the carrier of Example 1 of JP-A No. 2002-328493.

Specifically, the carrier is produced as follows.

### Production of Hydrophobic Iron Oxide

2646 grams of magnesium sulfate containing 9.9% by mass of magnesium element, and sodium carbonate are added to 57 liters of an aqueous ferrous sulfate solution containing 2.4 mol/l of Fe²⁺ ions to obtain a mixed aqueous solution having an adjusted pH value of 9. Sixty-five liters of an aqueous solution containing 4.4 mol/l of sodium hydroxide is mixed with the mixed aqueous solution. While the temperature is kept at 80° C., air is blown into the resultant at 40 liter/min to grow crystal for 30 minutes. 6.5 liters of an aqueous ferrous sulfate solution containing 2.4 moth of Fe²⁺ ions is added to a slurry of iron hydroxide including seed crystal particles. While an aqueous sodium hydroxide solution is added to the resultant, air is blown into the resultant system at 40 liter/min at pH of 8 to 9 at 85° C. for six hours to complete oxidation reaction. After the completion of the reaction, the obtained magnetite slurry is washed, filtered, dried, and pulverized by conventional methods. The magnetite particles obtained in such a manner have a total magnesium content of 2.1% by mass and a total amount of magnesium existing on the surface of 0.26% by mass.

Hundred parts by mass of the magnetite is surface-treated with 0.5 parts by mass of γ-glycidyltrimethoxysilane to obtain hydrophobic iron oxide 1.

Production of carrier

| | |
|---|---|
| Phenol (hydroxybenzene) | 50 parts by mass |
| Aqueous 37 mass % formalin solution | 80 parts by mass |
| Water | 50 parts by mass |
| Hydrophobic iron oxide 1 | 600 parts by mass |
| 25 mass % ammonia water | 15 parts by mass |

The above materials are put into a four-necked flask and the resultant mixture, which is being stirred, is heated to 85° C. over 60 minutes and kept at the temperature for 120 minutes to cure phenol and formalin. After that, the reaction product is cooled down to 30° C. and 500 parts by mass of water is added to the reaction product and the supernatant is removed and the resultant precipitate is washed with water and air-dried. The precipitate is further dried at a reduced pressure of 5 mmHg at a temperature in the range of 150 to 180° C. for 24 hours to obtain a carrier core having a phenol resin as the binder resin thereof.

The surface of the carrier core is coated with a toluene solution containing 5% by mass of γ-aminopropyltrimethoxysilane serving as a silane coupling agent.

The amount of γ-aminopropyltrimethoxysilane used in the surface treatment is 0.2% by mass. During the coating, shearing force is continuously applied to the carrier core and the toluene is evaporated. It has been confirmed that the following group exists on the surface of the treated carrier core.

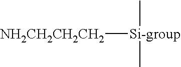

γ-Aminopropyltrimethoxysilane is added to a silicone resin KR-221 (manufactured by Shin-Etsu Chemical Co., Ltd.) in the content of 3% by mass of the silicone resin solid matter. The resultant mixture is diluted with toluene so that the concentration of the silicone resin solid matter becomes 20% by mass. The resultant mixture is added to the magnetic carrier core treated with the silane coupling agent, which is being stirred at 70° C., at a reduced pressure in the treatment apparatus to coat the core with the mixture. The coating amount of the silicone resin solid matter is 0.8 parts by mass with respect to 100 parts by mass of the carrier core.

After stirred for two hours, the coated core is heated at 140° C. for two hours in a nitrogen gas atmosphere and the agglomerates are loosened and coarse particles of 82 μm (200 mesh) or larger are removed from the core particles coated with the resin to obtain a carrier (13).

The total energy amount of the carrier (13) is shown in Table 2.

### Comparative Example 6

A carrier (14) is obtained in the same manner as in Example 8, except that the amounts of the styrene-butyl acrylate (80/20) copolymer and the perfluoroacrylate copolymer are changed to 15 parts by mass and 25 parts by mass, respectively. The total energy amount of the carrier (14) is shown in Table 2.

### <Production of Developer>

Production of toner by kneading and pulverizing

—Production of Toner a—
Polyester resin: 100 parts by weight
(linear polyester of terephthalic acid/bisphenol A ethylene oxide adduct/cyclohexane, having a weight-average molecular weight of 10,000);
Carbon black (REGAL 330 manufactured by Cabot Corp.): 6 parts by weight;

The mixture of the above components is kneaded by an extruder, and pulverized by a jet mill, and the resultant particles are classified. Subsequently, an external additive is added to the surfaces of the classified particles so as to obtain a black toner (toner a).

—Production of Toner b—

A Cyan toner (toner b) is obtained in the same manner as the toner a, except that the entire amount of the carbon black is replaced with 5 parts by weight of copper phthalocyanine blue pigment, C.I. Pigment Blue 15:3.

—Production of Toner c—

A Magenta toner (toner c) is obtained in the same manner as the toner a, except that the entire amount of the carbon black is replaced with 5 parts by weight of C.I. Pigment Red 57:1.

—Production of Toner d—

A Magenta toner (toner d) is obtained in the same manner as the toner a, except that the entire amount of the carbon black is replaced with 6 parts by weight of C.I. Pigment Yellow 180.

Six parts by weight of each of the toners is mixed with 100 parts by weight of each of the carriers of Examples 1 to 8 and Comparative Examples 1 to 6 to obtain sets (1) to (14) each having four color developers: yellow, magenta, cyan, and black toners.

### <Evaluation>

The following copying test is carried out with a remodeled apparatus by modifying DOCU PRINT C1616 manufactured by Fuji Xerox Co., Ltd., in which each of the developer sets (1) to (14) is set, at a peripheral speed of a magnet roll sleeve of 350 mm/sec.

The copying test is carried out by copying an image on 10000 sheets of paper at an ordinary temperature and an ordinary humidity (22° C. and 50% RH) at an area coverage of 0.5%. The image density, the fogging level, and the blank point level of each of the copied image on the tenth sheet (initial) and that on the 10000th sheet are evaluated in accordance with the following methods.

### Density Evaluation Method

An image of each color having sizes of 2 cm×5 cm is repeatedly printed, and the density of the printed image on the tenth sheet and that of the printed image on the 10000th sheet are measured with a reflection densitometer X-RITE 938 (manufactured by X-rite Corp.). The results are shown in Table 1 and the density values of each of Examples and Comparative Examples shown in Table 1 represents those of the black, cyan, magenta, and yellow images in that order. Namely, the first density is that of the black image.

The criteria for comprehensive evaluation are as follows.

A: The ratio of the density of the image on the 10000th sheet to that of the image on the tenth sheet is 97% or higher for all the colors.
B: The ratio of the density of the image on the 10000th sheet to that of the image on the tenth sheet is 95% or higher for all the colors.
C: The ratio of the density of the image on the 10000th sheet to that of the image on the tenth sheet is 90% or higher for all the colors.
D: The ratio of the density of the image on the 10000th sheet to that of the image on the tenth sheet is less than 90% for at least one of the four colors.

### Fogging Evaluation Method

The number of toner particles per 100 cm² of the white background portion of each of the images is counted.

The criteria for comprehensive evaluation are as follows.

A: inexistence of toner particles
B: less than three
C: not less than three and less than five
D: six particles or more

### Blank Point/Colored Point Evaluation Method

A full-size image with an area coverage of 100% is printed on an A4 size sheet of paper and the number of blank points is counted. Moreover, no image is printed on another A4 size sheet of paper and the number of colored points is counted.

The criteria for comprehensive evaluation are as follows.

A: inexistence of blank and colored points
B: less than five in total:
C: not less than five and less than 10 in total
D: 10 or more in total.

### Comprehensive Evaluation

Given points for the marks A, B, C and D in the respective evaluation items of density, fogging level, and colored point level are 0, 1, 2 and 3, respectively, the sum of the points of all the items is evaluated in the following criteria. Marks A and B are at a practically acceptable level.

A: The sum is 3 or less.

### B: The sum is 4 to 6.

### C: The sum is 7 to 9.

D: The sum is 10 or higher.

The obtained evaluation results are shown in Tables 1 and 2.

TABLE 1

| | | | Initial image quality | | | Image quality after 10000th printing | | | |
|---|---|---|---|---|---|---|---|---|---|
| | | | | | No. of | | | No. of | |
| | Total | Peripheral | | Fogging | blank | | Fogging | blank | Comprehensive |
| | energy | speed (m/sec) | Density | level | points | Density | level | points | evaluation |
| Example 1 | 2400 | 350 | 1.30 | 0 | 0 | 1.28 | 1 | 0 | A |
| | | | 1.41 | | | 1.40 | | | |
| | | | 1.35 | | | 1.32 | | | |
| | | | 1.38 | | | 1.38 | | | |
| Example 2 | 3000 | 350 | 1.32 | 1 | 1 | 1.28 | 1 | 4 | B |
| | | | 1.39 | | | 1.38 | | | |
| | | | 1.34 | | | 1.32 | | | |
| | | | 1.40 | | | 1.38 | | | |
| Example 3 | 1900 | 350 | 1.29 | 1 | 1 | 1.25 | 1 | 1 | B |
| | | | 1.35 | | | 1.34 | | | |
| | | | 1.35 | | | 1.35 | | | |
| | | | 1.38 | | | 1.32 | | | |
| Example 4 | 1500 | 350 | 1.33 | 1 | 1 | 1.33 | 2 | 1 | B |
| | | | 1.42 | | | 1.37 | | | |
| | | | 1.39 | | | 1.35 | | | |
| | | | 1.42 | | | 1.38 | | | |
| Example 5 | 2300 | 350 | 1.31 | 0 | 1 | 1.30 | 0 | 1 | A |
| | | | 1.33 | | | 1.33 | | | |
| | | | 1.34 | | | 1.33 | | | |
| | | | 1.34 | | | 1.33 | | | |
| Example 6 | 1300 | 350 | 1.30 | 0 | 1 | 1.29 | 0 | 2 | A |
| | | | 1.38 | | | 1.35 | | | |
| | | | 1.38 | | | 1.33 | | | |
| | | | 1.33 | | | 1.32 | | | |
| Example 7 | 1500 | 350 | 1.32 | 1 | 1 | 1.31 | 1 | 4 | B |
| | | | 1.35 | | | 1.33 | | | |
| | | | 1.38 | | | 1.35 | | | |
| | | | 1.40 | | | 1.35 | | | |
| Example 8 | 1000 | 350 | 1.30 | 1 | 1 | 1.25 | 2 | 1 | B |
| | | | 1.30 | | | 1.24 | | | |
| | | | 1.35 | | | 1.30 | | | |
| | | | 1.34 | | | 1.30 | | | |

TABLE 2

| | | Peripheral | Initial image quality | | | Image quality after 10000th printing | | | |
|---|---|---|---|---|---|---|---|---|---|
| | Total | speed | | Fogging | No. of blank | | Fogging | No. of blank | Comprehensive |
| | energy | (m/sec) | Density | level | points | Density | level | points | evaluation |
| Comparative | 3800 | 350 | 1.32 | 1 | 1 | 1.18 | 3 | 10 | D |
| Example 1 | | | 1.38 | | | 1.25 | | | |
| | | | 1.36 | | | 1.26 | | | |
| | | | 1.38 | | | 1.24 | | | |
| Comparative | 3500 | 350 | 1.30 | 1 | 1 | 1.20 | 3 | 7 | C |
| Example 2 | | | 1.36 | | | 1.27 | | | |
| | | | 1.35 | | | 1.27 | | | |
| | | | 1.38 | | | 1.31 | | | |
| Comparative | 3100 | 350 | 1.29 | 1 | 1 | 1.20 | 3 | 5 | C |
| Example 3 | | | 1.38 | | | 1.29 | | | |
| | | | 1.37 | | | 1.29 | | | |
| | | | 1.36 | | | 1.30 | | | |
| Comparative | 1400 | 350 | 1.33 | 2 | 1 | 1.20 | 6 | 1 | C |
| Example 4 | | | 1.40 | | | 1.30 | | | |
| | | | 1.38 | | | 1.30 | | | |
| | | | 1.36 | | | 1.31 | | | |
| Comparative | 1600 | 350 | 1.31 | 1 | 1 | 1.25 | 3 | 6 | C |
| Example 5 | | | 1.33 | | | 1.21 | | | |
| | | | 1.35 | | | 1.28 | | | |
| | | | 1.35 | | | 1.30 | | | |
| Comparative | 900 | 350 | 1.30 | 1 | 1 | 1.19 | 7 | 1 | C |
| Example 6 | | | 1.39 | | | 1.27 | | | |
| | | | 1.29 | | | 1.20 | | | |
| | | | 1.30 | | | 1.20 | | | |

As shown in Tables 1 and 2, when carriers for electrostatic image development having magnetic particles and a coating layer on the surface of each of the magnetic particles have a total energy amount, measured by the powder rheometer under the aforementioned conditions, in the range of 1500 mJ to 3000 mJ, or when those having magnetic powder-dispersed particles and a coating layer on the surface of each of the particles have a total energy amount, measured by the powder rheometer under the aforementioned conditions, in the range of 1000 mJ to 1500 mJ, the fluidity is good and therefore, occurrence of fogging due to breakage of the carrier, and images having missing portions caused by powder generated by the breakage of the carrier can be prevented. Further, since the fluidity is good, the transfer property is also good and image density is sufficient.

### Examples 9 to 15 and Comparative Examples 7 to 15

### Production of Mother Toner

### Production of Mother Toner (21)

Polyester resin: 100 parts by mass (linear polyester of terephthalic acid-bisphenol A ethylene oxide adduct-cyclohexanedimethanol having Tg of 62° C., Mn of 12000, and Mw of 32000); Cyan coloring agent (C.I. Pigment Blue 15:3): 4 parts by mass

A mixture of the above components is kneaded by an extruder and pulverized by a jet mill, and the resultant particles are classified by an air blow-type classifier to obtain cyan mother toner particles (21) with an average particle diameter of 6.2 p.m.

### <Production of External Additive>

Production of Toner (21) with External Additives

0.8 Parts by weight of rutile-type titanium oxide (treated with n-decyltrimethoxysilane, and having a particle diameter of 20 nm and a specific gravity of 4.1) and 1.0 part by weight of silica (produced by a vapor-phase oxidation method, treated with silicone oil, and having a particle diameter of 40 nm and a specific gravity of 2.2) are mixed with 100 parts by weight of the mother toner particles (21) by Henshel mixer to obtain a toner (21) with external additives.

Production of Toners (22) to (26) with External Additives

Toners (22) to (26) with external additives are produced in the same manner as the toner (21) with external additives, except that the particle diameters of titanium oxide and silica are changed to values shown in Table 3.

Production of Toner (27) with External Additives

A toner (27) with external additives is produced in the same manner as a toner a of Examples of JP-A No. 2004-170714.

Specifically, the production is carried out as follows.

### Production of Toner Particles a

### Production of Resin Particle Dispersion Liquid (1)

| | | |
|---|---|---|
| Styrene | 370 | parts by weight |
| n-Butyl acrylate | 30 | parts by weight |
| Acrylic acid | 8 | parts by weight |
| Dodecanethiol | 24 | parts by weight |
| Carton tetrabromide | 4 | parts by weight |

The above-mentioned components are mixed to obtain a raw material solution. The raw material solution is added to a solution obtained by dissolving six parts by weight of a nonionic surfactant (NONIPOL 400 manufactured by Sanyo Chemical Industries, Ltd.) and ten parts by weight of an anionic surfactant (NEOGEN SC manufactured by Dai-Ichi Kogyo Seiyaku Co., Ltd.) in 550 parts by weight of deionized water and dispersion and emulsification is carried out in a flask. A solution obtained by dissolving four parts by weight of ammonium persulfate in 50 parts by weight of deionized water is added to the resultant mixture, which is being stirred slowly for 10 minutes. After air in the flask is replaced with nitrogen, the content in the flask, which is being stirred, are heated in an oil bath to 70° C. and kept at 70° C. for five hours to carry out emulsion polymerization. Thus, a resin particle dispersion liquid (1) is obtained. The resin particles in the dispersion liquid have an average particle diameter of 155 nm, Tg of 59° C., and a weight-average molecular weight Mw of 12,000.

### Production of Resin Particle Dispersion Liquid (2)

| | |
|---|---|
| Styrene | 280 parts by weight |
| n-Butyl acrylate | 120 parts by weight |
| Acrylic acid | 8 parts by weight |

The above-mentioned components are mixed to obtain a raw material solution. The raw material solution is added to a solution obtained by dissolving six parts by weight of a nonionic surfactant (NONIPOL 400 manufactured by Sanyo Chemical Industries, Ltd.) and 12 parts by weight of an anionic surfactant (NEOGEN SC manufactured by Dai-Ichi Kogyo Seiyaku Co., Ltd.) in 550 parts by weight of deionized water and dispersion and emulsification is carried out in a flask. A solution obtained by dissolving three parts by weight of ammonium persulfate in 50 parts by weight of deionized water is added to the resultant mixture, which is being stirred slowly for 10 minutes. After air in the flask is replaced with nitrogen, the content in the flask, which is being stirred, are heated in an oil bath to 70° C. and kept at 70° C. for five hours to carry out emulsion polymerization. Thus, a resin particle dispersion liquid (2) is obtained. The resin particles in the dispersion liquid have an average particle diameter of 105 nm, Tg of 53° C., and a weight-average molecular weight Mw of 550,000.

### Production of Coloring Agent Dispersion Liquid (1)

| | |
|---|---|
| Carbon black (MOGUL L manufactured by Cabot | 50 parts by weight |
| Corp.) | |
| Nonionic surfactant (NONIPOL 400 manufactured | 5 parts by weight |
| by Sanyo Chemical Industries, Ltd.) | |
| Deionized water | 200 parts by weight |

The above-mentioned components are mixed and stirred by a homogenizer (ULTRA TURRAX T50 manufactured by IKA Co.) for 10 minutes to obtain a coloring agent dispersion liquid (1) in which coloring agent (carbon black) particles with an average particle diameter of 250 nm are dispersed.

### Production of Releasing Agent Dispersion Liquid (1)

| | |
|---|---|
| Paraffin wax (HNP 0190 manufactured by Nippon | 50 parts by weight |
| Seiro Co., Ltd. and having a melting point of | |
| 85° C.) | |
| Cationic surfactant (SANISOL B 50 manufactured | 5 parts by weight |
| by Kao Corp.) | |
| Deionized water | 200 parts by weight |

The above-mentioned components are heated to 95° C., stirred by a homogenizer (ULTRA TURRAX T50 manufactured by IKA Co.) and further stirred by a pressure discharge-type homogenizer to obtain a releasing agent dispersion liquid (1) in which releasing agent particles with an average particle diameter of 550 nm are dispersed.

### Production of Agglomerate Dispersion Liquid

| | | |
|---|---|---|
| Resin particle dispersion liquid (1) | 120 | parts by weight |
| Resin particle dispersion liquid (2) | 80 | parts by weight |
| Coloring agent dispersion liquid (1) | 30 | parts by weight |
| Releasing agent dispersion liquid (1) | 40 | parts by weight |
| Cationic surfactant (SANISOL B 50 | 1.5 | parts by weight |
| manufactured by Kao Corp.) | | |

The above-mentioned components are mixed and stirred in a round-type flask made of stainless steel with a homogenizer (ULTRA TURRAX T50 manufactured by IKA Co.). The content in the flask, which is being stirred, is heated to 50° C. in an oil bath for heating. Thereafter, the resultant mixture is cooled down to 45° C. and kept at that temperature for 25 minutes to obtain an agglomerate dispersion liquid. The agglomerates of the agglomerate dispersion liquid is observed with an optical microscope, and the average particle diameter thereof is found to be about 5.0 μm.

### Production of Adhesion Particle Liquid

Sixty parts by weight of the resin particle dispersion liquid (1) is slowly added to the agglomerate dispersion liquid. The resultant mixture is heated in an oil bath for heating whose temperature is increased to 50° C., and kept at that temperature for 40 minutes to obtain an adhesion particle dispersion liquid. The adhesion particles of the adhesion particle dispersion liquid is observed with an optical microscope, and the average particle diameter thereof is found to be about 5.8 μm.

### Production of Toner Mother Particle

Three parts by weight of an anionic surfactant (NEOGEN SC manufactured by Dai-Ichi Kogyo Seiyaku Co., Ltd.) is added to the adhesion particle dispersion liquid, and the resultant mixture is put into a flask made of stainless steel, and the flask is sealed. The mixture, which is being continuously stirred with a magnetic seal, is heated to 105° C. and kept at that temperature for four hours. Thereafter, the mixture is cooled down, and the reaction product is filtered out, sufficiently washed with deionized water, and dried to obtain toner mother particles. The toner mother particles a have a volume average particle diameter D₅₀ of 6.1 μm and a shape factor SF1 of 128.

One part by weight of each of the following external additives (1) and (2) is added to 100 parts by weight of the toner mother particles. The resultant blend is stirred by a Henshel mixer at 30 m/second for 10 minutes and sifted by a sieve with a 45 μm mesh to remove coarse particles. Thus, a toner a with external additives is obtained.

### External Additive (1)

Needle-shaped rutile-type titanium oxide particles treated with decylsilane compound (having a volume average particle diameter of 15 nm, and a powder resistance of 10¹³ Ω·cm)

### External Additive (2)

Spherical monodisperse silica particles (having a shape factor SF1 of 105, a volume average particle diameter of 135 nm, and a powder resistance of 10¹⁵ Ω·cm) obtained by subjecting silica sol, which is obtained by a sol-gel method, to HMSD treatment, and drying and pulverizing the resultant.

### <Production of Carrier>

### Production of Carrier (21)

Ferrite particles (including Cu—Zn, and having a density of 4.5 g/cm³, a volume average particle diameter of 35 μm, and a shape factor SF1 of 125) are classified with an elbow-jet device (Product No. EJ-LABO manufactured by Nittetsu Mining Co., Ltd.) at cut points of 25 μm and 45 μm to remove powder and coarse powder and to obtain core particles to be coated.

Regarding the particle diameter distribution of the obtained core particles to be coated, the particle size distribution index at a coarse particle side (D_{84V}/D_{50V}) is 1.18, and the particle size distribution index at a particle size (D₅₀ₚ/D₁₆ₚ) is 1.20, and the volume average particle diameter is 37 μm, and the shape factor SF1 is 124.

Twenty parts by mass of a toluene solution (solid content of 15 parts by mass) of styrene-methyl methacrylate copolymer (weight-average molecular weight of 80,000) is added to 100 parts by mass of the core particles to be coated. The resultant mixture is stirred by a batch-type kneader having a capacity of 50 liters and a jacket for 10 minutes. The mixture, which is being stirred, is heated to a temperature of 120° C. or higher and kept at that temperature for 20 minutes. Then, the mixture, which is being stirred, is cooled down until the temperature thereof is decreased to 60° C. Thereafter, the resultant coated particles are taken out. The coated particles are classified three times with the elbow-jet device under the above-described conditions to remove powder and coarse powder. Thus, a carrier (21) is obtained.

Regarding the particle diameter distribution of the carrier (21), the particle size distribution index at a coarse particle side is 1.15, and the particle size distribution index at a particle size is 1.16, and the volume average particle diameter is 37 μm, and the shape factor SF1 is 123.

The total energy amount of the carrier (21) is measured with POWDER RHEOMETER FT4 (manufactured by Freeman Technology) in the above-described manner. The concrete measurement method is as follows.

At first, an auxiliary tool is attached to the upper side of a container having a capacity of 160 ml. The carrier (21) is put into the container to overflow the container. Next, the container charged with the carrier (21) is set in a measurement apparatus and a rotor manufactured by Freeman Technology, a propeller-type blade having a diameter of 48 mm and a width of 10 mm and shown in FIG. 3, is set above the container. Conditioning is repeated four times at a helix angle of −5.0° and a tip end speed of the rotor of 60 mm/s.

Subsequently, the carrier (21) sufficiently degassed by the conditioning is leveled at the top end of the container and is transferred to a container having a capacity of 200 ml. The rotor is moved downward at an air flow of 10 cc/min at a helix angle of −10.0° and a tip end speed of the rotor of 100 mm/s from the top surface to the point which has a height of 10 mm from the bottom of the container (approach (migration) length of 70 mm). The integrated value of torque is obtained as the total energy amount. The total energy amount of the carrier (21) is 2170 mJ.

### Production of Carriers (22) and (23)

Carriers (22) and (23) are produced in the same manner as the carrier (21), except that the number of repeated times of the powder/coarse powder removal treatment conducted with the elbow-jet device to obtain a carrier coated with a resin is changed from three to a value within the range of 2 to 5. The total energy amount of each of the carriers (22) and (23) is shown in Table 3.

### Production of Carrier (24)

Ferrite particles (including Cu—Zn and having a density of 4.5 g/cm³, a volume average particle diameter of 35 μm, and a shape factor SF1 of 120) are classified with the elbow-jet device at cut points of 22 μm and 45 μm to remove powder and coarse powder and to obtain core particles to be coated.

Regarding the particle diameter distribution of the obtained core particles to be coated, the particle size distribution index at a coarse particle side is 1.18, and the particle size distribution index at a particle size is 1.20, and the volume average particle diameter is 37 μm, and the shape factor SF1 is 118.

Sixty parts by mass of a toluene solution (solid content of 5% by mass) of methyl methacrylate-perfluorohexyl acrylate copolymer (having a copolymerization rate of the former monomer to the latter monomer of 80/20, and a weight-average molecular weight of 50,000, and manufactured by Sanyo Chemical Industries Ltd.) and 10 parts by mass of a toluene solution (solid content of 15% by mass) of styrene-methyl methacrylate copolymer (weight-average molecular weight of 80,000) are added to 100 parts by mass of the core particles to be coated. The resultant mixture is stirred by a batch-type kneader having a capacity of 50 liters and a jacket for 10 minutes. The mixture, which is being stirred, is heated to a temperature of 120° C. or higher and kept at that temperature for 20 minutes. Then, the mixture, which is being stirred, is cooled down until the temperature thereof is decreased to 60° C. Thereafter, the resultant coated particles are taken out, and sifted with a sieve having a pore size of 75 μm so as to remove coarse particles. Thus, a carrier (24) is obtained. The total energy amount of the carrier (24) is shown in Table 3.

### Production of Carrier (25)

| | |
|---|---|
| Styrene-butyl acrylate copolymer (80/20) | 30 parts by mass |
| (Mw = 1.9 × 10⁵) | |
| Methyl methacrylate-perfluorohexyl acrylate | 10 parts by mass |
| copolymer | |
| Magnetite (EPT-1000 manufactured by Toda | 100 parts by mass |
| Kogyo Corp.) | |

The above components are melted and mixed by a pressurizing kneader, and pulverized and made spherical by a turbo-mill and a heat treatment apparatus. Further, the resultant particles are classified by the elbow-jet device four times at cut points of 22 μm and 45 μm to obtain a carrier (25).

Regarding the particle diameter distribution of the carrier (25), the particle size distribution index at a coarse particle side is 1.17, and the particle size distribution index at a particle size is 1.19, and the volume average particle diameter is 33 μm, and the shape factor SF1 is 110, and the density is 3.5 g/cm³. The total energy amount of the carrier (25) is shown in Table 3.

### Production of Carrier (26)

A carrier (26) is produced in the same manner as the carrier (25), except that the number of repeated times of the classification treatment are changed to three. The total energy amount of the carrier (26) is shown in Table 3.

### Production of Carrier (27)

A carrier (27) is produced in the same manner as the carrier (25), except that the amount of the styrene-butyl acrylate copolymer (80/20) is changed to 30 parts by mass and the amount of the methyl methacrylate-perfluorohexyl acrylate copolymer is changed to 20 parts by mass. The total energy amount of the carrier (27) is shown in Table 3.

### Production of Carrier (28)

The carrier (28) is produced in the same manner as the carrier (21), except that the number of repeated times of the powder/coarse powder removal by the elbow-jet at the same cut points is changed to once. The total energy amount of the carrier (28) is shown in Table 3.

### Production of Carrier (29)

Ferrite particles (including Cu—Zn and having a density of 4.5 g/cm³, a volume average particle diameter of 35 μm, and a shape factor SF1 of 110) are classified with the elbow-jet device to remove powder and coarse powder and to obtain core particles to be coated. Regarding the particle diameter distribution of the obtained core particles to be coated, the particle size distribution index at a coarse particle side is 1.18, and the particle size distribution index at a particle size is 1.20, and the volume average particle diameter is 37 μm, and the shape factor SF1 is 109.

Sixty parts by mass of a toluene solution (solid content of 5% by mass) of perfluorohexyl methacrylate-methyl methacrylate copolymer (having a weight-average molecular weight of 50,000, and manufactured by Sanyo Chemical Industries Ltd.) and 10 parts by mass of a toluene solution (solid content of 15% by mass) of styrene-methyl methacrylate copolymer (weight-average molecular weight of 75,000) are added to 100 parts by mass of the core particles to be coated. The resultant mixture is stirred by a batch-type kneader having a capacity of 50 liters and a jacket for 10 minutes. The mixture, which is being stirred, is heated to a temperature of 120° C. or higher and kept at that temperature for 20 minutes. Then, the mixture, which is being stirred, is cooled down until the temperature thereof is decreased to 60° C. Thus, a carrier (29) is obtained. The total energy amount of the carrier (29) is shown in Table 3.

### Production of Carrier (30)

### —Carrier of Example 1 of JP-A No. 2002-328493—

A carrier (30) having a magnetic powder-dispersed particle as the core is produced in the same manner as the carrier of Example 1 of JP-A No. 2002-328493. The production method is the same as in Comparative Example 5 of this specification. The total energy amount of the carrier (30) is shown in Table 3.

### Production of Carrier (31)

A carrier (31) is produced in the same manner as the carrier (27), except that the amounts of styrene-butyl acrylate (80/20) copolymer and perfluoroacrylate copolymer are changed to 15 parts by mass and 25 parts by mass, respectively. The total energy amount of the carrier (31) is shown in Table 3.

### Production of Carrier (32)

A carrier (32) is produced in the same manner as the carrier (I) described in Examples of JP-A No. 2004-170714. Specifically, the production is carried out as follows.

### Production of Coating Resin A

Thirty-eight parts by weight of methyl methacrylate, 50 parts by weight of isobutyl methacrylate, 2 parts by weight of methacrylic acid, and 10 parts by weight of perfluorooctylethyl methacrylate are randomly copolymerized by solution-polymerization in toluene serving as a solvent to obtain a coating resin A with a weight-average molecular weight Mw of 52,000.

### Production of Carrier

| | | |
|---|---|---|
| Ferrite particles (Mn—Mg ferrite particles | 100 | parts by weight |
| having a true specific gravity of 4.7 g/cm³, a | | |
| volume average particle diameter of 40 μm, a | | |
| saturation magnetization of 66 emu/g, and a shape | | |
| factor SF1 of 114) | | |
| Coating resin A | 1.4 | parts by weight |
| Carbon black (VXC-72 manufactured by Cabot | 0.12 | parts by weight |
| Corp.) | | |
| Cross-linked melamine resin particles (toluene- | 0.3 | parts by weight |
| insoluble EPOSTAR S manufactured Nippon | | |
| Shokubai Kagaku Kogyo Co., Ltd.) | | |
| POLYWAX 725 POWDER (having a melting | 0.3 | parts by weight |
| point of 103° C., and manufactured by Toyo- | | |
| Petrolite Co., Ltd.) | | |
| Toluene | 14 | parts by weight |

The coating resin A, carbon black, and cross-linked melamine resin particles are added to toluene and the resultant mixture is stirred by a sand mill to produce a solution for resin coating layer formation. The solution and ferrite particles are put into a vacuum-deaerating-type kneader and stirred at 60° C. for 10 minutes. Then, the internal pressure is reduced to distill and remove toluene and to form a resin coating layer on the surfaces of the ferrite particles. Thereafter, POLYWAX 725 POWDER is added to the coated particles and the resulting mixture is stirred at 110° C. for 10 minutes. Then, the particles coated with the resin coating layer are sieved with a net with an aperture size of 75 μm to obtain a carrier (32). The coating rate of the resin coating layer is 95%. The total energy amount of the carrier (32) is shown in Table 3.

### <Production of Developer>

### Production of Developer (21)

Hundred parts by mass of the carrier (21) is mixed with 7 parts by mass of the toner (21) with external additives (1) with a V-blender at 40 rpm for 20 min to produce a developer (21).

### Production of Developers (22) to (36)

Developers (22) to (36) are produced in the same manner as the developer (21), except the types of the carriers and the toners with external additives used are changed as shown in Table 3.

### <Evaluation>

The developers (21) to (36) are subjected to a copying test using a modified apparatus of Docu Print Color manufactured by Fuji Xerox Co., Ltd. at sleeve peripheral speed of a magnet roll of 200 mm/sec.

The following copying test is carried out with a remodeled apparatus by modifying DOCUPRINT COLOR manufactured by Fuji Xerox Co., Ltd., in which each of the developers (21) to (36) is set, at a peripheral speed of a magnet roll sleeve of 200 mm/sec.

The copying test is carried out by copying an image on 20000 sheets of paper at a low temperature and a low humidity (10° C. and 15% RH) at an area coverage of 80%. The image density, the fogging level, and the blank point/colored point level of each of the copied image on the tenth sheet (initial) and that on the 20000th sheet are evaluated in accordance with the following methods.

### Development Amount (Density) Evaluation Method

When an image with two solid patches each having a size of 2 cm×5 cm is copied, the printer is deliberately stopped before transferring a toner image to paper, and the development amount (amount of the toner which has not been transferred to paper) is measured. Specifically, precisely weighed two adhesive tapes are prepared and respectively pressed against two portions of a developed image (toner image) on the surface of a latent image-holding member, and the toner in the portions is transferred to the tapes. Then, the tapes to which the toner has been transferred are again precisely weighed. The weights of the tapes to which the toner has been transferred are respectively subtracted from those of the tapes including no toner and the differences are averaged to obtain the development amount.

The criteria are as follows. Marks A and B are at a practically acceptable level.

A: development amount of 4.5±0.5 g/m²
B: development amount of 4.5±0.6 g/m²
C: development amount of 4.5±0.75 g/m²
D: development amount of 4.5±a tolerance of 0.75 g/m² or higher

### Fogging Evaluation Method

When the toner is transferred from the surface of the latent image-holding member (photoconductor) to the tapes in the development amount evaluation method, another adhesive tape is pressed against a background portion of the developed image which background portion is apart from one of the solid patches by 10 mm, and the number of toner particles transferred to the tape (per cm²) is counted.

The criteria are as follows. Marks A and B are at a practically acceptable level.

A: less than 50 particles
B: not less than 50 particles and less than 100 particles
C: not less than 100 particles and less than 200 particles
D: 200 particles or more

### Blank Point/Colored Point Evaluation Method

A full-size half-tone image with an area coverage of 30% is printed on an A3 size sheet of paper and the number of colored points and blank points (missing portions of an image) is counted.

The criteria are as follows. Marks A and B are at a practically acceptable level.

A: no colored point and blank point
B: less than 5 points in total
C: not less than 5 points and less than 10 points in total
D: 10 or more points in total

### Comprehensive Evaluation

Given points for the marks A, B, C and D in the respective evaluation items of density, fogging level, and colored point level are 0, 1, 2 and 3, respectively, the sum of the points of all the items is evaluated in the following criteria. Marks A and B are at a practically acceptable level.

A: The sum is 5 or less.

### B: The sum is 6 or 7.

### C: The sum is 8 or 9.

D: The sum is 10 or higher.

TABLE 3

| | | Total | | External additive | | External additive | | Periph- | | | | Image quality after | | | Compre- |
|---|---|---|---|---|---|---|---|---|---|---|---|---|---|---|---|
| | | energy | | Ti | | Si | | eral | Initial image quality | | | 20,000th printing | | | hensive |
| | Car- | of | | | % By | | % By | speed | | | Blank | | | Blank | eval- |
| | rier | carrier | Toner | D50 | weight | D50 | weight | (m/sec) | Density | Fogging | point | Density | Fogging | point | uation |
| Ex. 9 | (21) | 2170 | (21) | 20 | 0.8 | 40 | 1 | 200 | B | A | A | B | B | A | A |
| Ex. 10 | (23) | 1420 | (21) | 20 | 0.8 | 40 | 1 | 200 | B | B | A | B | C | B | B |
| Ex. 11 | (24) | 2190 | (22) | — | — | 30 | 1.5 | 200 | B | A | A | C | B | A | A |
| Ex. 12 | (22) | 2910 | (21) | 20 | 0.8 | 40 | 1 | 200 | B | A | A | C | B | C | B |
| Ex. 13 | (25) | 910 | (21) | 20 | 0.8 | 40 | 1 | 200 | B | A | A | B | B | B | A |
| Ex, 14 | (26) | 1190 | (23) | 15 | 1.2 | — | — | 200 | B | A | A | B | B | C | B |
| Ex. 15 | (27) | 1340 | (21) | 20 | 0.8 | 40 | 1 | 200 | B | B | A | C | C | B | B |
| Comp. | (28) | 3400 | (21) | 20 | 0.8 | 40 | 1 | 200 | B | A | A | D | D | C | C |
| Ex. 7 | | | | | | | | | | | | | | | |
| Comp. | (29) | 1330 | (21) | 20 | 0.8 | 40 | 1 | 200 | B | C | A | C | D | D | D |
| Ex. 8 | | | | | | | | | | | | | | | |
| Comp. | (21) | 2170 | (24) | — | — | 50 | 2.2 | 200 | B | A | A | C | D | C | C |
| Ex. 9 | | | | | | | | | | | | | | | |
| Comp. | (21) | 2170 | (25) | 8 | 1.2 | — | — | 200 | B | B | A | C | C | C | C |
| Ex. 10 | | | | | | | | | | | | | | | |
| Comp. | (30) | 1450 | (22) | — | — | 30 | 1.5 | 200 | B | A | A | D | C | D | C |
| Ex. 11 | | | | | | | | | | | | | | | |
| Comp. | (31) | 840 | (23) | 15 | 1.2 | — | — | 200 | B | C | A | C | D | C | D |
| Ex, 12 | | | | | | | | | | | | | | | |
| Comp. | (25) | 910 | (26) | — | — | 43 | 2 | 200 | C | A | A | C | D | D | C |
| Ex. 13 | | | | | | | | | | | | | | | |
| Comp. | (25) | 910 | (25) | 8 | 1.2 | — | — | 200 | B | B | A | C | D | D | D |
| Ex. 14 | | | | | | | | | | | | | | | |
| Comp. | (32) | 4060 | (27) | 15 | As | 135 | As | 200 | B | C | B | C | D | D | D |
| Ex. 15 | | | | | described | | described | | | | | | | | |
| | | | | | in JP-A | | in JP-A | | | | | | | | |
| | | | | | No. 2004- | | No. 2004- | | | | | | | | |
| | | | | | 170714 | | 170714 | | | | | | | | |

As shown in Table 3, developers each containing a carrier having a total energy amount, measured by a powder rheometer under the above conditions, within the range recited in the invention, and a toner containing an external additive having a volume average particle diameter of about 10 to about 40 nm have good fluidity, which suppresses adhesion of the external additive to the carrier, stabilizes charge/resistance for a long period of time and enables output of high quality images.

### Examples 16 to 23 and Comparative Examples 16 to 21

### Production of Toner Particles

### Production of Toner Particles (41)

| | |
|---|---|
| Polyester resin (linear polyester of terephthalic | 85 parts by mass |
| acid/bisphenol A ethylene oxide adduct/ | |
| cyclohexanedimethanol having Tg of 60° C., Mn | |
| of 3,600, Mw of 28,000 and an acid value of 15) | |
| Vegetable wax (carnauba wax) | 6 parts by mass |
| SiO₂ particles (R 972 manufactured by Nippon | 3 parts by mass |
| Aerosil Co., Ltd.) | |
| C.I. Pigment Blue 15:3 | 6 parts by mass |

The above components are sufficiently preliminarily mixed by a Henshel mixer, melted and kneaded by a Banbury mixer, cooled and rolled, preliminarily pulverized, and finely pulverized by a jet mill. The resultant particles are made spherical by a fluidized bed-type heating treatment apparatus SFP-LABO (manufactured Powrex Co., Ltd.) at a dry air amount of one liter/min at a set dry air temperature of 70° C. at a blade rotation speed of 500 rpm for 60 minutes, and classified by a classifier elbow-jet (manufactured by Matsusaka Boeki Co., Ltd.) utilizing Coanda effect to obtain toner mother particles (41) for a cyan toner.

In the toner mother particles (41), the volume average particle diameter thereof is 6.0 μm, and the ratio of the number of toner mother particles having a particle diameter of 4 μm or smaller to that of all the toner mother particles is 5% by number, and the ratio of the total volume of toner mother particles having a particle diameter of 16 μm or larger to that of all the toner mother particles is 1% by volume, and the shape factor SF1 thereof is 132.

Hundred parts by mass of the toner mother particles are mixed with 1.0 part by mass of hydrophobic titanium oxide particles having a diameter of 30 nm (STT30A manufactured by Titan Kogyo K.K.) and 1.0 part by mass of hydrophobic silica particles having a diameter of 40 nm (RX 50 manufactured by Nippon Aerosil Co., Ltd.) serving as external additives by a Henshel mixer to produce toner particles (41).

### Production of Toner Particles (42)

Toner mother particles (42) are produced in the same manner as the toner mother particles (41), except that making the particles spherical is conducted for 90 minutes (The other conditions in making the particles spherical are the same as those in producing the toner mother particles (41).

In the toner mother particles (42), the volume average particle diameter thereof is 5.9 μm, and the ratio of the number of toner mother particles having a particle diameter of 4 μm or smaller to that of all the toner mother particles is 4.9% by number, and the ratio of the total volume of toner mother particles having a particle diameter of 16 μm or larger to that of all the toner mother particles is 1.1% by volume, and the shape factor SF1 thereof is 128.

Toner particles (42) are produced in the same manner as the toner particles (41), except that the toner mother particles (42) are used as particles to be mixed with the external additives in place of the toner mother particles (41).

### Production of Toner Particles (43)

Toner mother particles (43) are produced in the same manner as the toner mother particles (41), except that making the particles spherical is conducted for 30 minutes (The other conditions in making the particles spherical are the same as those in producing the toner mother particles (41).

In the toner mother particles (43), the volume average particle diameter thereof is 6.1 μm, and the ratio of the number of toner mother particles having a particle diameter of 4 μm or smaller to that of all the toner mother particles is 5.1% by number, and the ratio of the total volume of toner mother particles having a particle diameter of 16 μm or larger to that of all the toner mother particles is 1% by volume, and the shape factor SF1 thereof is 139.

Toner particles (43) are produced in the same manner as the toner particles (41), except that the toner mother particles (43) are used as particles to be mixed with the external additives in place of the toner mother particles (41).

### Production of Toner Particles (44)

Toner mother particles (44) are produced in the same manner as the toner mother particles (41), except that making the particles spherical is conducted for five minutes (The other conditions in making the particles spherical are the same as those in producing the toner mother particles (41).

In the toner mother particles (44), the volume average particle diameter thereof is 5.1 μm, and the ratio of the number of toner mother particles having a particle diameter of 4 μm or smaller to that of all the toner mother particles is 5.1% by number, and the ratio of the total volume of toner mother particles having a particle diameter of 16 μm or larger to that all the toner mother particles is 4.9% by volume, and the shape factor SF1 thereof is 146.

Toner particles (44) are produced in the same manner as the toner particles (41), except that the toner mother particles (44) are used as particles to be mixed with the external additives in place of the toner mother particles (41).

### <Production of Carrier>

Production of carrier (41)

Ferrite particles (Mn—Mg-Ferrite particles having a true specific gravity of 4.5 g/cm³, a volume average particle diameter of 35 μm, and a shape factor SF1 of 125) are classified by an elbow-jet (EJ-LABO manufactured by Nittetsu Mining Co., Ltd.) to remove powder and coarse powder and to obtain core particles to be coated.

Regarding the particle diameter distribution of the core particles to be coated, the particle size distribution index at a coarse particle side (D_{84V}/D_{50V}) is 1.18, and the particle size distribution index at a particle size (D₅₀ₚ/D₁₆ₚ) is 1.20, and the volume average particle diameter is 37 μm, and the shape factor SF1 is 124.

Twenty parts by mass of a toluene solution (solid content of 15 parts by mass) of styrene-methyl methacrylate copolymer (having a copolymerization rate of the former monomer to the latter monomer of 20/80, and a weight-average molecular weight of 80,000, and manufactured by Mitsubishi Rayon Co., Ltd.) is added to 100 parts by mass of the core particles to be coated. The resultant mixture is stirred by a batch-type kneader having a capacity of 50 liters and a jacket for 10 minutes. The mixture, which is being stirred, is heated to a temperature of 120° C. or higher and kept at that temperature for 20 minutes. Then, the mixture, which is being stirred, is cooled down until the temperature thereof is decreased to 60° C. Thereafter, the resultant coated particles are taken out. The coated particles are classified three times with the elbow-jet device to remove powder and coarse powder. Thus, a carrier (41) is obtained.

Regarding the particle diameter distribution of the carrier (41), the particle size distribution index at a coarse particle side is 1.15, and the particle size distribution index at a particle size is 1.16, and the volume average particle diameter is 37 μm, and the shape factor SF1 is 123.

The total energy amount of the carrier (41) is measured with POWDER RHEOMETER FT4 (manufactured by Freeman Technology) in the above-described manner. The concrete measurement method is as follows.

At first, an auxiliary tool is attached to the upper side of a container having a capacity of 160 ml. The carrier (41) is put into the container to overflow the container. Next, the container charged with the carrier (41) is set in a measurement apparatus and a rotor manufactured by Freeman Technology, a blade having a diameter of 48 mm and a width of 10 min, is set above the container. Conditioning is repeated four times at a helix angle of −5.0° and a tip end speed of the rotor of 60 mm/s.

Subsequently, the carrier (41) sufficiently degassed by the conditioning is leveled at the top end of the container. The rotor is moved downward at a helix angle of −5.0° and a tip end speed of the rotor of 100 mm/s to the point which has a height of 10 mm from the bottom of the container (approach (migration) length of 70 mm). The integrated value of torque is obtained as the total energy amount. The total energy amount of the carrier (41) is 2400 mJ (mean value).

### Production of Carriers (42) and (43)

Carriers (42) and (43) are produced in the same manner as the carrier (1), except that the number of repeated times of the powder/coarse powder removal treatment for the resin coated carrier is changed from three to two (carrier 42) or four (carrier 43). The total energy amount of each of the carriers (42) and (43) is shown in Table 4.

### Production of Carrier (44)

| | |
|---|---|
| Styrene-butyl acrylate copolymer (80/20) | 30 parts by mass |
| (having a weight-average molecular weight | |
| of 190,000, and manufactured by Mitsubishi | |
| Rayon Co., Ltd.) | |
| Perfluoroacrylate copolymer | 10 parts by mass |
| Magnetite (EPT-1000 manufactured by Toda | 100 parts by mass |
| Kogyo Corp.) | |

The above components are melted and mixed by a pressurizing kneader, and pulverized and made spherical by a turbo-mill and a heat treatment apparatus. The resultant particles are classified by an elbow-jet classifier four times to obtain a carrier (44).

Regarding the particle diameter distribution of the carrier (44), the particle size distribution index at a coarse particle side is 1.17, and the particle size distribution index at a particle size is 1.19, and the volume average particle diameter is 33 and the shape factor SF1 is 110, and the true specific gravity is 3.5 g/cm³. The total energy amount of the carrier (44) is shown in Table 4.

### Production of Carrier (45)

A carrier (45) is produced in the same manner as the carrier (44), except that the number of repeated times of the classification treatment are changed to three. The total energy amount of the carrier (45) is shown in Table 4.

### Production of Carrier (46)

A carrier (46) is produced in the same manner as the carrier (44), except that the amount of the styrene-butyl acrylate copolymer (80/20) is changed to 30 parts by mass and the amount of the perfluoroacrylate copolymer is changed to 20 parts by mass. The total energy amount of the carrier (46) is shown in Table 4.

### Production of Comparative Carrier (47)

Ferrite particles (Mn—Mg ferrite particles having a true specific gravity of 4.5 g/cm³, a volume average particle diameter of 35 μm, and a shape factor SF1 of 125) are not classified. Twenty parts by mass of a toluene solution (solid content of 15 parts by mass) of styrene-methacrylate copolymer is added to 100 parts by mass of the ferrite particles. The resultant mixture is stirred by a batch-type kneader having a capacity of 50 liters and a jacket for 10 minutes. The mixture, which is being stirred, is heated to a temperature of 120° C. or higher and kept at that temperature for 20 minutes. Then, the mixture, which is being stirred, is cooled down until the temperature thereof is decreased to 60° C. Thereafter, the resultant coated particles are taken out, and sifted with a sieve having a pore size of 75 μm so as to remove coarse particles. Thus, a comparative carrier (47) is obtained.

The total energy amount of the carrier (47) is 3800 mJ.

### Production of Comparative Carrier (48)

A comparative carrier (48) is produced in the same manner as the carrier (41), except that the number of repeated times of the powder/coarse powder removal treatment by the elbow-jet classifier is changed from three to six. The total energy amount of the comparative carrier (48) is shown in Table 4.

Production of Comparative Carrier (49)

A comparative carrier (49) is produced in the same manner as the carrier (46), except that the amount of the styrene-butyl acrylate copolymer (80/20) is changed to 15 parts by mass and the amount of the perfluoroacrylate copolymer is changed to 25 parts by mass. The total energy amount of the carrier (49) is shown in Table 4.

### Production of Comparative Carrier (50)

A comparative carrier (50) is produced in the same manner as the carrier (44), except that the amount of magnetite (EPT-1000 manufactured by Toda Kogyo Corp.) is changed to 120 parts by mass and the classification treatment is repeated 3 times. The total energy amount of the comparative carrier (50) is shown in Table 4.

### Production of Comparative Carrier (51)

A comparative carrier (51) is produced in the same manner as the carrier described in Example 1 of JP-A No. 11-133672.

Specifically, the production method is as follows.

Twenty-three mol % of Li₂O₃ and 77 mol % of Fe₂O₃ are pulverized and mixed by a wet-type ball mill for three hours and dried. Thereafter, the mixture is kept at 900° C. for two hours so as to preliminarily bake the mixture and the resultant is pulverized by a ball mill for three hours to obtain a slurry. A dispersant and a binder are added to the slurry and the resultant mixture is granulated and dried by a spray drier. The resultant particles are baked at 1200° C. for three hours to obtain ferrite core particles with a volume average particle diameter of 60 μm.

Next, 100 parts by weight of a silicone resin (solid content of 50%) having a ratio of a segment represented by the following formula (I) to that represented by the following formula (II) of 2/98 and 0.2 parts by weight of γ-aminopropyltrimethoxysilane are added to toluene (solvent). The resultant solution and the ferrite core particles are put into a fluidized bed so as to coat the ferrite core particles with 0.5% by weight of the solution. The resultant coated particles are baked at 170° C. for two hours. Six hundred grams of the baked particles are stirred by a V-type mixer at 30 rpm for 60 minutes to obtain a carrier (51).

The total energy amount of the carrier (51) is 3900.

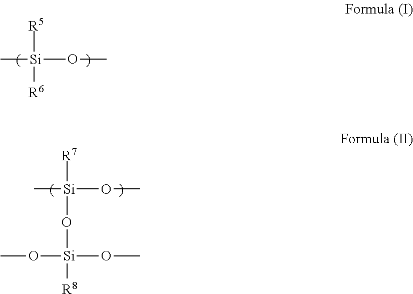

In this comparative carrier, R⁵ to R⁸ in formulas (I) and (II) are methyl groups.

### Example 16

### Production of Developer (41)

Hundred parts by mass of the carrier (41) and seven parts by mass of the toner particles (41) are mixed by a V-type mixer having an effective capacity of two liters at 40 rpm for 20 minutes to obtain a developer (41).

### Examples 17 and 18

### Production of Developers (42) and (43)

Developers (42) and (43) are produced in the same manner as the developer (41), except that the toner particles (41) are replaced with the toner particles (42) and (43), respectively.

### Examples 19 and 23

### Production of Developers (44) to (48)

Developers (44) to (48) are produced in the same manner as the developer (41), except that the carrier (41) is replaced with the carriers (42) to (46), respectively.

### Comparative Example 16

### Production of Comparative Developer (49)

A developer (49 is produced in the same manner as the developer (41), except that the toner particles (41) are replaced with the comparative toner particles (49).

### Examples 17 to 21

### Production of Comparative Developers (50) to (54)

Comparative developers (50) to (54) are produced in the same manner as the developer (41), except that the carrier (41) is replaced with the comparative carriers (47) to (51), respectively.

### <Evaluation>

A copying test is carried out with a remodeled apparatus by modifying DOCUPRINT COLOR manufactured by Fuji Xerox Co., Ltd., in which each of the developers (41) to (54) is set, at a peripheral speed of a latent image-holding member of 420 mm/sec at a ratio of the peripheral speed of a developer-carrying member to that of the latent image-holding member of 1.75.

The copying test is carried out by copying an image on 20000 sheets of paper at a low temperature and a low humidity (10° C. and 15% RH) at an area coverage of 80%. The image density, the fogging level, and the blank point/colored point level of each of the copied image on the tenth sheet (initial) and that on the 20000th sheet are evaluated in the same manner as in Example 9.

TABLE 4

| | Toner | | Carrier | | | | | | | | |
|---|---|---|---|---|---|---|---|---|---|---|---|
| | | Shape | | | Total energy | Initial image quality | | | Image quality after 20,000th printing | | |
| | No. | factor SF1 | No. | Core | of carrier | Density | Fogging | Bank point | Density | Fogging | Blank point |
| Ex. 16 | (41) | 132 | (41) | Ferrite particles | 2400 | A | A | A | A | A | A |
| Ex. 17 | (42) | 128 | (41) | Ferrite particles | 2400 | A | A | A | B | B | A |
| Ex. 18 | (43) | 139 | (41) | Ferrite particles | 2400 | A | A | A | A | A | B |
| Ex. 19 | (41) | 132 | (42) | Ferrite particles | 3000 | A | A | A | A | B | B |
| Ex. 20 | (41) | 132 | (43) | Ferrite particles | 1500 | A | A | A | B | A | A |
| Ex. 21 | (41) | 132 | (44) | Magnetic powder- | 1300 | A | A | A | A | B | A |
| | | | | dispersed particles | | | | | | | |
| Ex. 22 | (41) | 132 | (45) | Magnetic powder- | 1500 | A | A | A | B | B | B |
| | | | | dispersed particles | | | | | | | |
| Ex. 23 | (41) | 132 | (46) | Magnetic powder- | 1000 | A | A | A | B | B | A |
| | | | | dispersed particles | | | | | | | |
| Comp. Ex. 16 | (44) | 146 | (41) | Ferrite particles | 2400 | A | A | A | B | B | C |
| Comp. Ex. 17 | (41) | 132 | (47) | Ferrite particles | 1300 | A | A | A | C | B | B |
| Comp. Ex. 18 | (41) | 132 | (48) | Ferrite particles | 3800 | A | A | A | B | B | C |
| Comp. Ex. 19 | (41) | 132 | (49) | Magnetic powder- | 900 | B | B | B | C | C | B |
| | | | | dispersed particles | | | | | | | |
| Comp. Ex. 20 | (41) | 132 | (50) | Magnetic powder- | 1700 | A | A | A | B | C | C |
| | | | | dispersed particles | | | | | | | |
| Comp. Ex. 21 | (41) | 132 | (51) | Carrier described in | 3900 | B | B | A | C | D | C |
| | | | | Example 1 of JP-A No. | | | | | | | |
| | | | | 11-133672 | | | | | | | |

As shown in Table 4, when developers each contain a carrier having a total energy amount, measured by a powder rheometer under the aforementioned conditions, of 1500 to 3000 mJ for a carrier including a magnetic particle as the core and of 1000 to 1500 mJ for a carrier including a magnetic powder-dispersed particle as the core, and a toner having an average shape factor SF1 of 140 or lower, peeling of the resin coating layer of the carrier is suppressed, and charge/resistance is stabilized for a long period of time, and high quality images are outputted.

What is claimed is:

1. A developer for electrostatic image development containing a toner and a carrier, wherein the toner contains a binder resin, a coloring agent, and an external additive having a volume average particle diameter of 10 to 40 nm, and the carrier comprises a magnetic particle as a core and a coating layer coating the surface of the magnetic particle, and the total energy amount, measured with a powder rheometer at an air flow of 10 cc/min, a tip end speed of a rotor of 100 mm/s and a helix angle of the rotor of −10°, of a portion of the carrier in a measurement container which portion is contained in a region between a packed surface and a surface disposed under the packed surface by 70 mm is 1420 to 2920 mJ.

2. A carrier for electrostatic image development comprising:
a magnetic powder-dispersed particle as a core and a coating layer coating the surface of the magnetic powder-dispersed particle, wherein the total energy amount, measured with a powder rheometer at a tip end speed of a rotor of 100 mm/s and a helix angle of the rotor of −5°, of a portion of the carrier in a measurement container which portion is contained in a region between a packed surface and a surface disposed under the packed surface by 70 mm is 1000 to 1500 mJ.

3. The carrier for electrostatic image development of claim 2, wherein a ratio of a volume particle diameter D_{84V} to a volume average particle diameter D_{50V} is 1.20 or lower and a ratio of a number average particle diameter D_{50P} to a number particle diameter D_{16P} is 1.25 or lower.

4. The carrier for electrostatic image development of claim 2, wherein a density of the core is 2.0 to 5.0 g/cm³.

5. The carrier for electrostatic image development of claim 2, wherein a saturation magnetization of the carrier is 40 emu/g or higher.

6. The carrier for electrostatic image development of claim 2, wherein a volume electric resistance of the carrier is 1×10⁸ to 1×10¹⁴ Ω·cm.

7. The carrier for electrostatic image development of claim 2, wherein a content of the magnetic powder in the magnetic powder-dispersed particle is 30% by mass to 95% by mass.

8. A developer for electrostatic image development containing a toner for electrostatic image development and a carrier for electrostatic image development, wherein the toner for electrostatic image development comprises toner mother particles each containing a binder resin and a coloring agent and having an average shape factor SF1 of 140 or lower, and the carrier for electrostatic image development comprises a magnetic powder-dispersed particle as a core and a coating layer coating the surface of the magnetic particle, and the total energy amount, measured with a powder rheometer at a tip end speed of a rotor of 100 mm/s and a helix angle of the rotor of −5°, of a portion of the carrier in a measurement container which portion is contained in a region between a packed surface and a surface disposed under the packed surface by 70 mm is 1000 to 1500 mJ.

9. A developer for electrostatic image development containing a toner and a carrier, wherein the toner contains a binder resin, a coloring agent, and an external additive having a volume average particle diameter of 10 to 40 μm, and the carrier comprises a magnetic powder-dispersed particle as a core and a coating layer coating the surface of the magnetic powder-dispersed particle, and the total energy amount, measured with a powder rheometer at an air flow of 10 cc/min, a tip end speed of a rotor of 100 mm/s and a helix angle of the rotor of −10°, of a portion of the carrier in a measurement container which portion is contained in a region between a packed surface and a surface disposed under the packed surface by 70 mm is 890 to 1390 mJ.

10. An image formation method comprising:
electrically charging a latent image-holding member;
exposing the charged latent image-holding member to light to form an electrostatic latent image on the latent image-holding member;
developing the electrostatic latent image with a developer containing a toner and a carrier to form a toner image; and
transferring the toner image from the latent image-holding member to a recording material,
wherein the carrier comprises the carrier of claim 2 for electrostatic image development, and in the developing, a developer-carrying member is provided, faces the latent image-holding member, holds the developer on the surface thereof, and is rotated at a peripheral speed of 200 to 600 mm/s to transport the developer to the latent image-holding member.
